(19) United States
(12) Patent Application Publication
(10) Pub. No.: US 2024/0430721 A1
(43) Pub. Date: Dec. 26, 2024

(54) SYSTEMS AND METHODS FOR NETWORK PERFORMANCE EVALUATION

(71) Applicant: Verizon Patent and Licensing Inc., Basking Ridge, NJ (US)

(72) Inventors: Seng Gan, Ashburn, VA (US); Andrew F. Patka, Holliston, MA (US); Sankar Subramanian, Ossining, NY (US); Jason T. Wright, Novi, MI (US); Arun Cherla, Somerset, NJ (US)

(21) Appl. No.: 18/211,835

(22) Filed: Jun. 20, 2023

(51) Int. Cl. H04W 24/10; H04W 24/02

(52) U.S. Cl. CPC H04W 24/10; H04W 24/02

(57) ABSTRACT

In an example, an indication of one or more first network performance tests associated with a first testing computer and/or an indication of one or more second network performance tests associated with a second testing computer may be provided to a User Equipment (UE). One or more first test results of the one or more first network performance tests and/or one or more second test results of the one or more second network performance tests may be received. One or more first network performance metrics may be determined based upon the one or more first test results. One or more second network performance metrics may be determined based upon the one or more second test results. A network performance issue is determined based upon a comparison of one or more reference metrics with the one or more first network performance metrics and/or the one or more second network performance metrics.

### BACKGROUND

Wireless communication services, such as cellular services, wireless internet services, etc. may be used by organizations, companies, universities and other entities to interconnect people, machines, vehicles, sensors and other devices.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system comprising a network performance evaluation system, a network, a public network, a first testing computer and/or a second testing computer in accordance with an embodiment.

FIG. 1B is a diagram illustrating data flow associated with an example system comprising a network performance evaluation system, a network, a public network, a first testing computer and/or a second testing computer in accordance with an embodiment.

FIG. 2 is a flow chart illustrating an example method for determining a network performance issue in accordance with an embodiment.

FIG. 3A is a flow chart illustrating a first part of an example method for determining a network performance issue in accordance with an embodiment.

FIG. 3B is a flow chart illustrating a second part of an example method for determining a network performance issue in accordance with an embodiment.

FIG. 4 is a network diagram associated with a system in accordance with an embodiment.

FIG. 5 is a network diagram associated with a system in accordance with an embodiment.

FIG. 6 is a flow chart illustrating an example method for determining network performance test results using a User Equipment (UE) in accordance with an embodiment.

FIG. 7 is an illustration of an example environment in which at least a portion of the techniques presented herein may be utilized and/or implemented.

FIG. 8 is an illustration of an example network that may utilize and/or implement at least a portion of the techniques presented herein.

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

In accordance with some embodiments of the present disclosure, a network performance evaluation system is provided for evaluating (e.g., troubleshooting) network performance associated with telecommunication service provided to a User Equipment (UE). In an example, a user may contact a technical support service associated with the telecommunication service due to experiencing technical issues with the UE (e.g., at least one of weak service, inconsistent connection, low internet speed, etc.). In the example, operations provided herein may be triggered by the technical support service to identify and/or isolate a network performance issue associated with the UE. Alternatively and/or additionally, the operations provided herein may be triggered (e.g., automatically triggered) at regular and/or irregular intervals for monitoring network performance associated with the UE and/or network components associated with the telecommunication service. For example, the network performance evaluation system may provide the UE with instructions to perform an evaluation process including one or more first network performance tests with a first testing computer (e.g., an internal testing computer) and/or one or more second network performance tests with a second testing computer (e.g., an external testing computer). The first testing computer may be in an internal network associated with the telecommunication service, which may be connected to the UE via a wireless communication site (e.g., a base station) associated with the telecommunication service. The second testing computer may be outside the internal network (e.g., the second testing computer may be connected to the UE via an internet connection between the internal network and the second testing computer). The network performance evaluation system may gather derived test results of the one or more first network performance tests and/or the one or more second network performance tests, and use the test results to determine network performance metrics. The network performance evaluation system may use the network performance metrics to determine the network performance issue. One or more corrective actions may be performed in response to identifying the network performance issue. For example, the network performance evaluation may isolate a problem area associated with the network performance issue to a region of interest (e.g., a network segment and/or a section of a network, such as a transport network associated with the telecommunication service), and/or may allocate one or more resources to one or more components of the region of interest (to improve network performance of the one or more components, for example).

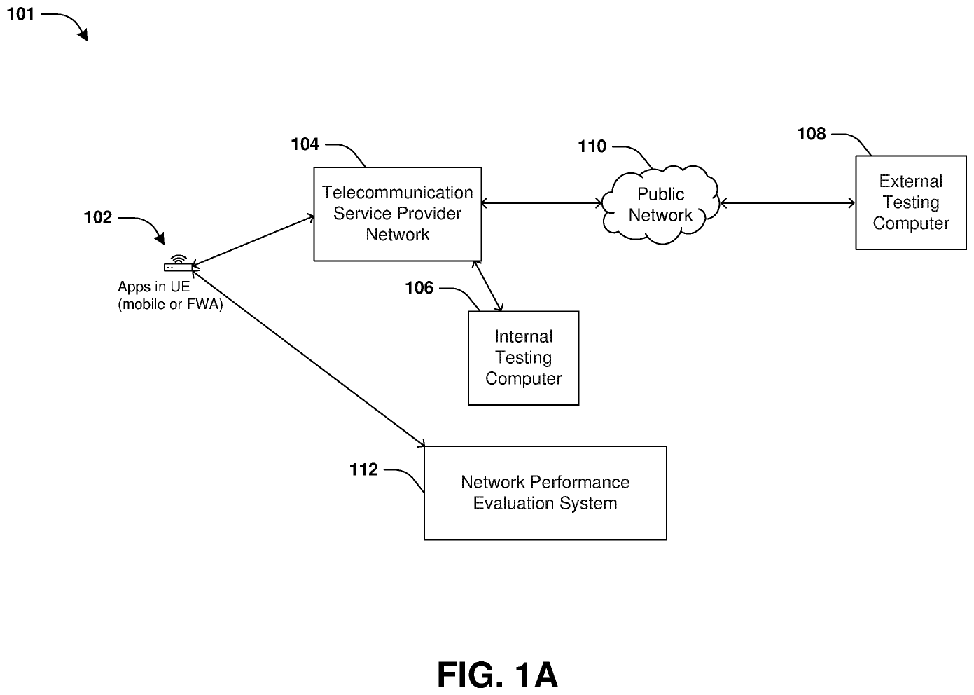

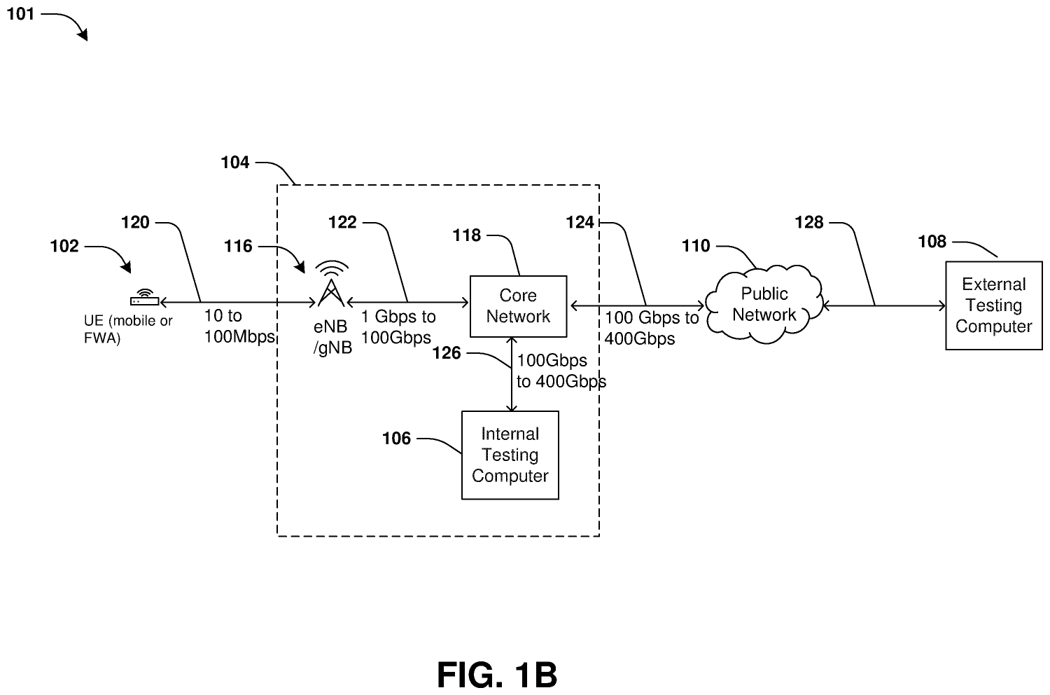

FIGS. 1A-1B illustrate an example of a system 101 comprising a network performance evaluation (e.g., troubleshooting) system 112, a network 104, a public network 110, a first testing computer 106 and/or a second testing computer 108. The network performance evaluation system 112 may be used to determine a network performance issue associated with a UE 102, the network 104.

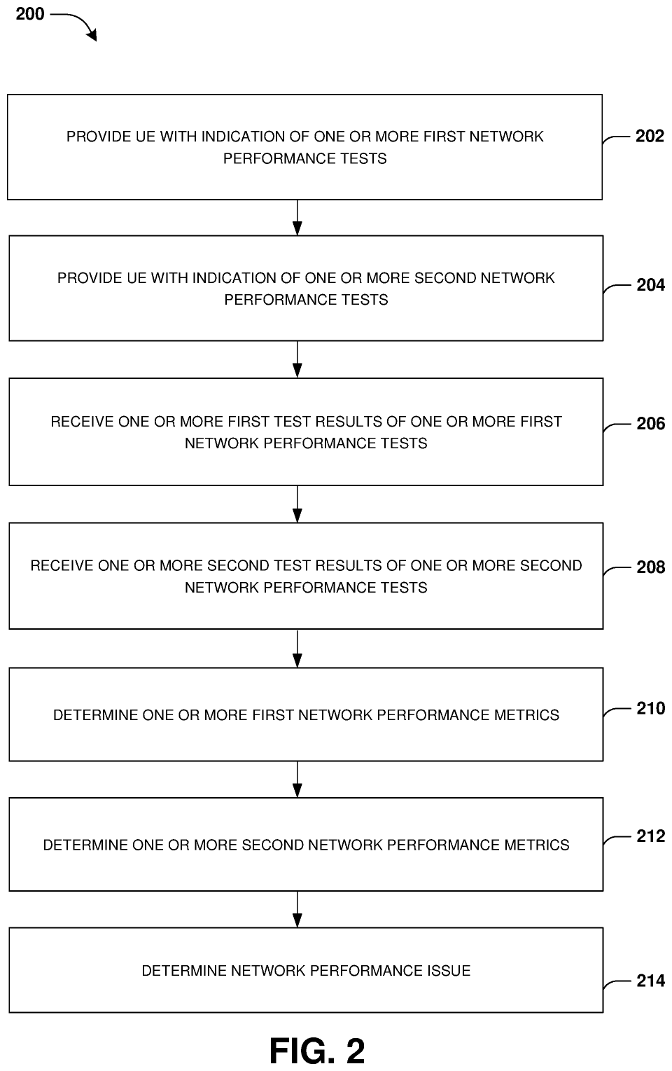

An embodiment of determining a network performance issue is illustrated by an example method 200 of FIG. 2, and is further described in conjunction with FIGS. 1A-1B. At 202, the network performance evaluation system 112 may provide the UE 102 with a first indication of a first set of (one or more) network performance tests. At 204, the network performance evaluation system 112 may provide the UE 102 with a second indication of a second set of (one or more) network performance tests. In some examples, the first indication and/or the second indication may be transmitted to the UE 102 together (e.g., in the same message and/or signal) or separately (e.g., in different messages and/or signals). In some examples, the first indication and/or the second indication may comprise a set of instructions for performing the first set of network performance tests and/or the second set of network performance tests.

In some examples, the set of instructions may be provided to the UE 102 and/or executed by the UE 102 via a network evaluation (e.g., troubleshooting) application (e.g., a mobile application, a web application, etc.) associated with the network performance evaluation system 112. In an example, the network evaluation application may be installed on the UE 102 (e.g., the network performance evaluation system 112 may provide an installation package to the UE 102, wherein the UE 102 may install the network evaluation application using the installation package).

In some examples, the set of instructions may be provided to the UE 102 and/or executed by the UE 102 via an evaluation configuration. For example, the network performance evaluation system 112 may transmit the evaluation configuration to the UE 102. The evaluation configuration may comprise the set of instructions. The evaluation configuration may be enabled and/or activated (by the UE 102 and/or the network performance evaluation system 112) to execute the set of instructions.

In some examples, the UE 102 executes the set of instructions to perform an evaluation process comprising one or more network performance tests. The set of instructions may be executed using the network evaluation application. In some examples, the set of instructions is executed by the UE 102 in response to receiving the set of instructions. In some examples, the UE 102 is provided with a web address (e.g., a Uniform Resource Locator (URL)). For example, the network performance evaluation system 112 may transmit the web address to the UE 102 (via at least one of a text message, an email, etc.). In some examples, the set of instructions is downloaded to the UE 102 and/or executed by the UE 102 in response to a selection of the web address (and/or in response to the UE 102 accessing an internet resource corresponding to the web address).

In some examples, the first set of network performance tests may be associated with communication between the UE 102 and a first testing computer 106 (e.g., a speed-test server). The second set of network performance tests may be associated with communication between the UE 102 and a second testing computer 108 (e.g., an external speed-test server, such as an internet speed-test server).

In some examples, a network performance test of the first set of network performance tests and/or the second set of network performance tests (e.g., each network performance test of the first set of network performance tests and/or each network performance test of the second set of network performance tests) is performed over a network 104. In some examples, the network 104 corresponds to an internal network of a telecommunication service provider. In some examples, the telecommunication service provider may use one or more wireless communication sites to provide telecommunication services (e.g., at least one of cellular service, 5G service, 4G service, internet service, and/or other type of telecommunication service).

In some examples, the UE 102 comprises at least one of a laptop, a phone, a tablet, a mobile hotspot device, a client-side router, a Fixed Wireless Access (FWA) device, etc. In an example, the UE 102 may be portable (e.g., mobile hotspot device, phone, tablet, etc.). In some examples, the UE 102 may be positioned at a fixed location (e.g., in at least one of a home, a home office, a satellite office, etc.) and/or may be used by one or more users (e.g., a household) at the fixed location to access one or more networks (e.g., the Internet). In some examples, the UE 102 may provide devices (e.g., devices that are within range of the UE 102) with network connections (e.g., Internet connections). For example, the UE 102 may be connected with a client device over a wireless local area network (WLAN). The UE 102 may have telecommunication service provided by the telecommunication service provider (via a connection with a wireless communication site of the telecommunication service provider, for example). When the UE 102 is within coverage of telecommunication service provided by the telecommunication service provider (e.g., when the UE 102 is within a threshold distance of a wireless communication site of the telecommunication service provider), the UE 102 may share the telecommunication service with the client device (over the WLAN, for example). In some examples, the UE 102 may comprise a smartphone, a wearable device, etc. that has a mobile hotspot (e.g., personal hotspot) function in addition to other features for at least one of calling, browsing, texting, etc. Alternatively and/or additionally, the UE 102 may comprise a portable hotspot (e.g., a dedicated and/or standalone hotspot device, such as a portable hotspot device comprising a modem and/or router) configured to provide the client device (and/or one or more other client devices within range) with network connections (e.g., Internet connections).

FIG. 1B illustrates data flow associated with communication between the UE 102 and testing computers including the first testing computer 106 and the second testing computer 108. In some examples, the network 104 comprises a first wireless communication site 116 (e.g., a base station of the telecommunication service provider), a core network 118 and/or the first testing computer 106.

In some examples, a network performance test of the first set of network performance tests (e.g., each network performance test of the first set of network performance tests) is performed over (i) one or more connections 120 (e.g., one or more wireless connections) between the UE 102 and the wireless communication site 116, (ii) one or more connections 122 between the wireless communication site 116 and the core network 118, and/or (iii) one or more connections 126 between the core network 118 and the first testing computer 106.

In some examples, a network performance test of the second set of network performance tests (e.g., each network performance test of the second set of network performance tests) is performed over (i) the one or more connections 120 between the UE 102 and the wireless communication site 116, (ii) the one or more connections 122 between the wireless communication site 116 and the core network 118, (iii) one or more connections 124 between the core network 118 and the public network 110, and/or (iv) one or more connections 128 between the public network 110 and the second testing computer 108.

In some examples, the one or more connections 120 may be associated with a first network bandwidth (e.g., between about 10 megabits per second (Mbps) to about 100 Mbps), the one or more connections 122 may be associated with a second network bandwidth (e.g., between about 1 gigabit per second (Gbps) to about 100 Gbps), the one or more connections 126 may be associated with a third network bandwidth (e.g., between about 100 Gbps to about 400 Gbps), and/or the one or more connections 124 may be associated with a fourth network bandwidth (e.g., between about 100 Gbps to about 400 Gbps).

In some examples, an uplink (UL) transmission from the UE 102 to the first testing computer 106 travels through connections with increasing network bandwidths (e.g., the one or more connections 120 having the first network bandwidth, followed by the one or more connections 122 having the second network bandwidth greater than the first network bandwidth, followed by the one or more connections 126 having the third network bandwidth greater than the second network bandwidth). In some examples, a downlink (DL) transmission from the first testing computer 106 to the UE 102 travels through connections with decreasing network bandwidths, which may result in network congestion and/or buffering having a greater impact on DL data flow from the first testing computer 106 to the UE 102 than on UL data flow from the UE 102 to the first testing computer 106.

In some examples, a UL transmission from the UE 102 to the second testing computer 108 travels through connections with increasing network bandwidths. In some examples, a DL transmission from the second testing computer 108 to the UE 102 travels through connections with decreasing network bandwidths, which may result in network congestion and/or buffering having a greater impact on DL data flow from the second testing computer 108 to the UE 102 than on UL data flow from the UE 102 to the second testing computer 108.

In some examples, the first set of network performance tests comprises (i) a first UL network performance test (e.g., a UL UDP network performance test), (ii) a first DL network performance test (e.g., a DL UDP network performance test), (iii) a first download network performance test (e.g., an internal download TCP network performance test), (iv) a first upload network performance test (e.g., an internal upload TCP network performance test), and/or (v) one or more other types of network performance tests.

In some examples, the second set of network performance tests comprises (i) a second download network performance test (e.g., an external download TCP network performance test), (ii) a second upload network performance test (e.g., an external upload TCP network performance test), and/or (iii) one or more other types of network performance tests. In some examples, one, some and/or all of the first set of network performance tests and/or the second set of network performance tests may be performed using a network performance measurement tool, such as “Iperf” and/or other tools.

In some examples, the first UL network performance test (e.g., the UL UDP network performance test) comprises a UL speed-test (e.g., a UL UDP speed-test). In some examples, in the first UL network performance test, the UE transmits first data to the first testing computer 106. The first data may comprise a first set of data packets (e.g., a sequence of fixed size data packets). In some examples, the UE 102 may transmit the first data (e.g., the first set of data packets) at a maximum configured speed of the UE 102. In some examples, the UE 102 transmits the first data using UDP (e.g., the first set of data packets may comprise UDP data packets). In some examples, a test result of the first UL network performance test is based upon a measure of data, of the first data transmitted by the UE 102, received by the first testing computer 106 within a first time period associated with the first UL network performance test. In an example, the measure of data may correspond to a quantity of data packets (of the first set of data packets transmitted by the UE 102, for example) received by the first testing computer 106 within the first time period. In some examples, the test result of the first UL network performance test is indicative of one or more metrics associated with UL data transfer from the UE 102 to the first testing computer 106, such as a UL data transfer speed. In some examples, the UL data transfer speed may be reflective of a UL data transfer speed through a segment, of a network path of transmission of the first set of data packets from the UE 102 to the first testing computer 106, that has a relatively low bandwidth (and thus relatively low data transfer speed) compared with other segments of the network path. Thus, in some examples, the UL data transfer speed may be reflective of a UL data transfer speed through a UL connection (e.g., wireless connection) of the one or more connections 120 between the UE 102 and the wireless communication site 116 (since the connection 120 has a lower bandwidth than other parts of the network path, for example).

In some examples, the first DL network performance test (e.g., the DL UDP network performance test) comprises a DL speed-test (e.g., a DL UDP speed-test). In some examples, in the first DL network performance test, the first testing computer 106 transmits second data to the UE 102. The second data may comprise a second set of data packets (e.g., a sequence of fixed size data packets). In some examples, the first testing computer 106 may transmit the second data (e.g., the second set of data packets) at a maximum configured speed of the first testing computer 106. In some examples, the first testing computer 106 transmits the second data using UDP (e.g., the set of data packets may comprise UDP data packets). In some examples, a test result of the first DL network performance test is based upon a measure of data, of the second data transmitted by the first testing computer 106, received by the UE 102 within a second time period associated with the first DL network performance test. In an example, the measure of data may correspond to a quantity of data packets (of the second set of data packets transmitted by the first testing computer 106, for example) received by the UE 102 within the second time period. In some examples, the test result of the first DL network performance test is indicative of one or more metrics associated with DL data transfer from the first testing computer 106 to the UE 102, such as a DL data transfer speed. In some examples, the DL data transfer speed may be reflective of a DL data transfer speed through a DL connection (e.g., wireless connection) of the one or more connections 120 between the UE 102 and the wireless communication site 116.

In some examples, the first download network performance test (e.g., the internal download TCP network performance test) comprises a download speed-test (e.g., a download TCP speed-test). In some examples, in the first download network performance test, the first testing computer 106 transmits third data to the UE 102. The third data may comprise a third set of data packets. In some examples, the first testing computer 106 may transmit one or more data packets (e.g., a TCP window of data packets). In some examples, once the one or more data packets (e.g., the TCP window of data packets) are transmitted, the first testing computer 106 ceases (e.g., temporarily ceases) transmitting data packets to the UE 102. For example, the first testing computer 106 may wait for an acknowledgment (e.g., a TCP acknowledgment packet) from the UE 102 before sending one or more (subsequent) data packets (e.g., a second TCP window of data packets) to the UE 102. The acknowledgment may indicate reception of the one or more data packets by the UE 102. In some examples, the first download network performance test is performed while running a ping (e.g., a continuous ping) from the UE 102 to the first testing computer 106. In an example, the UE 102 (and/or the first testing computer 106) may (i) establish the ping before, upon, and/or after a beginning of the first download network performance test and/or (ii) stop the ping before, upon and/or after completion of the first download network performance test.

In some examples, the first download network performance test comprises a single thread download TCP test (performed using a single thread, for example) in which the first testing computer 106 may (i) transmit one or more data packets (e.g., a TCP window of data packets), (ii) after transmitting the one or more data packets, monitor for an acknowledgment (indicating reception of the one or more data packets by the UE 102, for example), and/or (iii) transmit one or more subsequent data packets (e.g., a subsequent TCP window of data packets) in response to receiving the acknowledgment.

In some examples, the first download network performance test comprises a multiple thread download TCP test associated with a plurality of threads. In an example, for each thread of the plurality of threads, the first testing computer 106 may (i) transmit one or more data packets (e.g., a TCP window of data packets), (ii) after transmitting the one or more data packets, monitor for an acknowledgment (indicating reception of the one or more data packets by the UE 102, for example), and/or (iii) transmit one or more subsequent data packets (e.g., a subsequent TCP window of data packets) in response to receiving the acknowledgment.

In some examples, a test result of the first download network performance test is based upon a measure of data, of the third data transmitted by the first testing computer 106, received by the UE 102 within a third time period associated with the first download network performance test. In an example, the measure of data may correspond to a quantity of data packets (e.g., data packets transmitted by the first testing computer 106 during the first download network performance test) received by the UE 102 within the third time period. In some examples, the test result of the first download network performance test is based upon a duration of time between (i) a transmission of data (e.g., a transmission of a TCP window of data packets) by the first testing computer 106 to the UE 102 during the first download network performance test, and (ii) reception of an acknowledgment, by the first testing computer 106, indicating reception of the transmission of data by the UE 102. In some examples, the test result of the first download network performance test is indicative of one or more metrics associated with data transfer (e.g., TCP data transfer) between the first testing computer 106 and the UE 102 in the first download network performance test, such as at least one of a round trip time, a download speed (e.g., TCP download speed), etc.

In some examples, in the first download network performance test, an acknowledgment (e.g., a TCP acknowledgment packet) is required for a round trip time (e.g., each round trip time of the first download network performance test) between the UE 102 and the first testing computer 106. For example, TCP network performance associated with downloading data from the first testing computer 106 to the UE 102 in the first download network performance test is dependent upon UL performance and DL performance. For example, the UE 102 transmitting acknowledgments (e.g., a TCP acknowledgment packet in response to one or more TCP data packets from the first testing computer 106) to the first testing computer 106 (in UL direction) more quickly and/or at a faster rate may provide for increased download speed in the first download network performance test. Alternatively and/or additionally, increased DL data transfer speed of data packets (e.g., TCP data packets) from the first testing computer 106 to the UE 102 may provide for increased download speed in the first download network performance test.

In some examples, the first upload network performance test (e.g., the internal upload TCP network performance test) comprises an upload speed-test (e.g., an upload TCP speed-test). In some examples, in the first upload network performance test, the UE 102 transmits fourth data to the first testing computer 106. The fourth data may comprise a fourth set of data packets. In some examples, the UE 102 may transmit one or more data packets (e.g., a TCP window of data packets). In some examples, once the one or more data packets (e.g., the TCP window of data packets) are transmitted, the UE 102 ceases (e.g., temporarily ceases) transmitting data packets to the first testing computer 106. For example, the UE 102 may wait for an acknowledgment (e.g., a TCP acknowledgment packet) from the UE 102 before sending one or more (subsequent) data packets (e.g., a second TCP window of data packets) to the first testing computer 106. The acknowledgment may indicate reception of the one or more data packets by the first testing computer 106. In some examples, the first upload network performance test is performed while running a ping (e.g., a continuous ping) from the UE 102 to the first testing computer 106. In an example, the UE 102 (and/or the first testing computer 106) may (i) establish the ping before, upon, and/or after a beginning of the first upload network performance test, and/or (ii) stop the ping before, upon and/or after completion of the first upload network performance test.

In some examples, the first upload network performance test comprises a single thread upload TCP test (performed using a single thread, for example). Alternatively and/or additionally, the first upload network performance test may comprise a multiple thread upload TCP test associated with a plurality of threads. In some examples, a test result of the first upload network performance test is based upon a measure of data, of the fourth data transmitted by the UE 102, received by the first testing computer 106 within a fourth time period associated with the first upload network performance test. In an example, the measure of data may correspond to a quantity of data packets (e.g., data packets transmitted by the UE 102 during the first upload network performance test) received by the first testing computer 106 within the fourth time period. In some examples, the test result of the first upload network performance test is based upon a duration of time between (i) a transmission of data (e.g., a transmission of a TCP window of data packets) by the UE 102 to the first testing computer 106 during the first upload network performance test, and (ii) reception of an acknowledgment, by the UE 102, indicating reception of the transmission of data by the first testing computer 106. In some examples, the test result of the first upload network performance test is indicative of one or more metrics associated with data transfer (e.g., TCP data transfer) between the first testing computer 106 and the UE 102 in the first upload network performance test, such as at least one of a round trip time, an upload speed (e.g., TCP upload speed), etc.

In some examples, in the first upload network performance test, an acknowledgment (e.g., a TCP acknowledgment packet) is required for a round trip time (e.g., each round trip time of the first upload network performance test) between the UE 102 and the first testing computer 106. For example, TCP network performance associated with uploading data from the UE 102 to the first testing computer 106 in the first upload network performance test is dependent upon UL performance and DL performance. In some examples, the first upload network performance test may be performed using one or more of the techniques provided herein with respect to the first download network performance test.

In some examples, the second download network performance test (e.g., the external download TCP network performance test) comprises a download speed-test (e.g., a download TCP speed-test). In some examples, in the second download network performance test, the second testing computer 108 transmits fifth data to the UE 102. The fifth data may comprise a fifth set of data packets. In some examples, the second testing computer 108 may transmit one or more data packets (e.g., a TCP window of data packets). In some examples, once the one or more data packets (e.g., the TCP window of data packets) are transmitted, the second testing computer 108 ceases (e.g., temporarily ceases) transmitting data packets to the UE 102. For example, the second testing computer 108 may wait for an acknowledgment (e.g., a TCP acknowledgment packet) from the UE 102 before sending one or more (subsequent) data packets (e.g., a second TCP window of data packets) to the UE 102. The acknowledgment may indicate reception of the one or more data packets by the UE 102. In some examples, the second download network performance test is performed while running a ping (e.g., a continuous ping) from the UE 102 to the first testing computer 106 (and/or the second testing computer 108). In an example, the UE 102 (and/or the first testing computer 106 and/or the second testing computer 108) may (i) establish the ping before, upon, and/or after a beginning of the second download network performance test and/or (ii) stop the ping before, upon and/or after completion of the second download network performance test.

A test result of the second download network performance test may be based upon a measure of data, of the fifth data transmitted by the second testing computer 108, received by the UE 102 within a fifth time period associated with the second download network performance test (e.g., the measure of data may correspond to a quantity of data packets received by the UE 102 within the fifth time period). In some examples, the test result is indicative of one or more metrics associated with data transfer (e.g., TCP data transfer) between the second testing computer 108 and the UE 102 in the second download network performance test, such as at least one of a round trip time, a download speed (e.g., TCP download speed), etc. In some examples, the second download network performance test is performed using one or more of the techniques provided herein with respect to performing the first download network performance test.

In some examples, the second upload network performance test (e.g., the external upload TCP network performance test) comprises an upload speed-test (e.g., an upload TCP speed-test). In some examples, in the second upload network performance test, the UE 102 transmits sixth data to the second testing computer 108. The sixth data may comprise a sixth set of data packets. In some examples, the UE 102 may transmit one or more data packets (e.g., a TCP window of data packets). In some examples, once the one or more data packets (e.g., the TCP window of data packets) are transmitted, the UE 102 ceases (e.g., temporarily ceases) transmitting data packets to the second testing computer 108. For example, the UE 102 may wait for an acknowledgment (e.g., a TCP acknowledgment packet) from the UE 102 before sending one or more (subsequent) data packets (e.g., a second TCP window of data packets) to the second testing computer 108. The acknowledgment may indicate reception of the one or more data packets by the second testing computer 108. In some examples, the second upload network performance test is performed while running a ping (e.g., a continuous ping) from the UE 102 to the first testing computer 106 (and/or the second testing computer 108). In an example, the UE 102 (and/or the first testing computer 106 and/or the second testing computer 108) may (i) establish the ping before, upon, and/or after a beginning of the second upload network performance test and/or (ii) stop the ping before, upon and/or after completion of the second upload network performance test.

A test result of the second upload network performance test may be based upon a measure of data, of the sixth data transmitted by the UE 102, received by the second testing computer 108 within a sixth time period associated with the second upload network performance test (e.g., the measure of data may correspond to a quantity of data packets received by the second testing computer 108 within the sixth time period). In some examples, the test result is indicative of one or more metrics associated with data transfer (e.g., TCP data transfer) between the second testing computer 108 and the UE 102 in the second upload network performance test, such as at least one of a round trip time, an upload speed (e.g., TCP upload speed), etc. In some examples, the second upload network performance test is performed using one or more of the techniques provided herein with respect to performing the first upload network performance test.

At 206, the network performance evaluation system 112 may receive a first set of (one or more) test results of the first set of network performance tests. At 208, the network performance evaluation system 112 may receive a second set of (one or more) test results of the second set of network performance tests. In some examples, the first set of test results and/or the second set of test results may be received by the network performance evaluation system 112 together (e.g., in the same message and/or signal) or separately (e.g., in different messages and/or signals). In some examples, the first set of test results and/or the second set of test results may be provided to the network performance evaluation system 112 by the UE 102. Embodiments are contemplated in which the first set of test results and/or the second set of test results are provided to the network performance evaluation system 112 by one or more components different than the UE 102, such as the first testing computer 106 and/or the second testing computer 108.

At 210, the network performance evaluation system 112 may determine a first set of (one or more) network performance metrics (e.g., internal network performance metrics) based upon the first set of test results. The first set of network performance metrics may be associated with communication between the UE 102 and the first testing computer 106 in the first set of network performance tests.

In some examples, one, some and/or all of the first set of network performance metrics may be the same as one or more metrics indicated by one or more test results of the first set of test results. In some examples, one, some and/or all of the first set of network performance metrics may be different than metrics indicated by one or more test results of the first set of test results. In some examples, at least some of the first set of network performance metrics are derived from metrics indicated by the first set of test results. For example, two or more metrics indicated by one or more test results of the first set of test results may be combined (e.g., by performing one or more operations, such as mathematical operations) to determine a network performance metric of the first set of network performance metrics.

In some examples, the first set of network performance metrics comprises a radio frequency (RF) connection metric associated with a wireless connection (of the one or more connections 120 shown in FIG. 1B, for example) between the UE 102 and the wireless communication site 116. For example, the RF connection metric may be indicative of a RF signal quality of the wireless connection (used to send data between the UE 102 and the first testing computer 106, for example). In some examples, the RF connection metric may be determined based upon the test result of the first UL network performance test and/or the test result of the first UL network performance test (and/or one or more test results of one or more other network performance tests). Embodiments are contemplated in which the RF connection metric is determined via a network performance test of the second set of network performance tests associated with the second testing computer 108 (and/or determined via a network performance test associated with a different, such as a third, testing computer). The RF connection metric may be indicative of a DL RF connection metric (e.g., DL RF signal quality) and/or a UL RF connection metric (e.g., UL RF signal quality). The DL RF connection metric may be determined based upon the test result of the first DL network performance test (e.g., the DL UDP network performance test). The UL RF connection metric may be determined based upon the test result of the first UL network performance test (e.g., the UL UDP network performance test). In some examples, the RF connection metric (e.g., the DL RF connection metric and/or the UL RF connection metric) may be determined based upon at least one of a received signal strength, a Reference Signal Received Power (RSRP), Reference Signal Received Quality (RSRQ), a Channel Quality Indicator (CQI), a Signal to Interference and/or Noise Ratio (SINR), a data transfer speed, a bandwidth, etc. measured via one or more tests of the first set of network performance tests.

In some examples, the first set of network performance metrics comprises a UL network performance metric associated with network performance of uplink data transfer from the UE 102 to the first testing computer 106. The UL network performance metric may be determined based upon the test result of the first UL network performance test. For example, the UL network performance metric may be determined based upon at least one of the UL data transfer speed, a throughput, a bandwidth, etc. measured via the first UL network performance test. In an example, the UL network performance metric may be equal to the UL data transfer speed.

In some examples, the first set of network performance metrics comprises a DL network performance metric associated with network performance of uplink data transfer from the UE 102 to the first testing computer 106. The DL network performance metric may be determined based upon the test result of the first DL network performance test. For example, the DL network performance metric may be determined based upon at least one of the DL data transfer speed, a throughput, a bandwidth, etc. measured via the first DL network performance test. In an example, the DL network performance metric may be equal to the DL data transfer speed.

In some examples, the first set of network performance metrics comprises a first download network performance metric (e.g., an internal download TCP network performance metric) associated with network performance associated with downloading data (e.g., TCP data packets) from the first testing computer 106 to the UE 102. The first download network performance metric may be determined based upon the test result of the first download network performance test (e.g., the internal download TCP network performance test). For example, the first download network performance metric may be determined based upon at least one of the round trip time, the download speed (e.g., the TCP download speed), a throughput, a bandwidth, etc. measured via the first download network performance test. In an example, the first download network performance metric may be equal to the download speed indicated by the test result of the first download network performance test.

In some examples, the first set of network performance metrics comprises a first download round trip time associated with downloading data (e.g., TCP data packets) from the first testing computer 106 to the UE 102. The first download round trip time may be determined based upon the test result of the first download network performance test. In an example, the first download round trip time may be based upon (e.g., equal to) the round trip time indicated by the test result of the first download network performance test.

In some examples, the first set of network performance metrics comprises a first upload network performance metric (e.g., an internal upload TCP network performance metric) associated with network performance associated with uploading data (e.g., TCP data packets) from the UE 102 to the first testing computer 106. The first upload network performance metric may be determined based upon the test result of the first upload network performance test (e.g., the internal upload TCP network performance test). For example, the first upload network performance metric may be determined based upon at least one of the round trip time, the upload speed (e.g., the TCP upload speed), a throughput, a bandwidth, etc. measured via the first upload network performance test. In an example, the first upload network performance metric may be equal to the upload speed indicated by the test result of the first upload network performance test.

In some examples, the first set of network performance metrics comprises a first upload round trip time associated with uploading data (e.g., TCP data packets) from the first testing computer 106 to the UE 102. The first upload round trip time may be determined based upon the test result of the first upload network performance test. In an example, the first upload round trip time may be based upon (e.g., equal to) the round trip time indicated by the test result of the first upload network performance test.

At 212, the network performance evaluation system 112 may determine a second set of (one or more) network performance metrics (e.g., external network performance metrics) based upon the second set of test results. The second set of network performance metrics may be associated with communication between the UE 102 and the second testing computer 108 in the second set of network performance tests.

In some examples, one, some and/or all of the second set of network performance metrics may be the same as one or more metrics indicated by one or more test results of the second set of test results. In some examples, one, some and/or all of the second set of network performance metrics may be different than metrics indicated by one or more test results of the second set of test results. In some examples, at least some of the second set of network performance metrics are derived from metrics indicated by the second set of test results. For example, two or more metrics indicated by one or more test results of the second set of test results may be combined (e.g., by performing one or more operations, such as mathematical operations) to determine a network performance metric of the second set of network performance metrics.

In some examples, the second set of network performance metrics comprises a second download network performance metric (e.g., an external download TCP network performance metric) associated with network performance associated with downloading data (e.g., TCP data packets) from the second testing computer 108 to the UE 102. The second download network performance metric may be determined based upon the test result of the second download network performance test (e.g., the external download TCP network performance test). For example, the second download network performance metric may be determined based upon at least one of the round trip time, the download speed (e.g., the TCP download speed), a throughput, a bandwidth, etc. measured via the second download network performance test. In an example, the second download network performance metric may be equal to the download speed indicated by the test result of the second download network performance test.

In some examples, the second set of network performance metrics comprises a second download round trip time associated with downloading data (e.g., TCP data packets) from the second testing computer 108 to the UE 102. The second download round trip time may be determined based upon the test result of the second download network performance test. In an example, the second download round trip time may be based upon (e.g., equal to) the round trip time indicated by the test result of the second download network performance test.

In some examples, the second set of network performance metrics comprises a second upload network performance metric (e.g., an external upload TCP network performance metric) associated with network performance associated with uploading data (e.g., TCP data packets) from the UE 102 to the second testing computer 108. The second upload network performance metric may be determined based upon the test result of the second upload network performance test (e.g., the external upload TCP network performance test). For example, the second upload network performance metric may be determined based upon at least one of the round trip time, the upload speed (e.g., the TCP upload speed), a throughput, a bandwidth, etc. measured via the second upload network performance test. In an example, the second upload network performance metric may be equal to the upload speed indicated by the test result of the second upload network performance test.

In some examples, the second set of network performance metrics comprises a second upload round trip time associated with uploading data (e.g., TCP data packets) from the UE 102 to the second testing computer 108. The second upload round trip time may be determined based upon the test result of the second upload network performance test. In an example, the second upload round trip time may be based upon (e.g., equal to) the round trip time indicated by the test result of the second upload network performance test.

At 214, the network performance evaluation system 112 may determine a first network performance issue based upon the first set of network performance metrics and/or the second set of network performance metrics. In some examples, the network performance evaluation system 112 may determine the first network performance issue based upon a comparison of a set of (one or more) reference metrics with (i) one or more metrics of the first set of network performance metrics and/or (ii) one or more metrics of the second set of network performance metrics. In some examples, one or more corrective actions may be performed in response to determining the first network performance issue.

In some examples, a reference metric of the set of reference metrics (e.g., each reference metric of one, some and/or all of the set of reference metrics) corresponds to a threshold with which a network performance metric may be compared to determine whether the network performance metric is reflective of a network performance issue (e.g., malfunctioning network segment), such as lower data transfer speeds relative to at least one of an average data transfer speed, a minimum data transfer speed indicated by a service plan associated with the UE 102 and/or the telecommunication service provider, etc.

In some examples, a first reference metric of the set of reference metrics may be associated with operation of a node (e.g., the wireless communication site 116) of a network (e.g., the network 104) when a congestion level of the node does not meet a threshold congestion level. For example, the first reference metric may be determined (via an experiment, for example) by performing a first reference network performance test using the node (e.g., the wireless communication site 116) when the congestion level of the node does not meet (e.g., does not exceed) the threshold congestion level. In an example, the threshold congestion level is about zero and/or corresponds to a negligible amount of network congestion (e.g., the node has about zero congestion and/or a negligible amount of congestion when the first reference network performance test is performed). The threshold congestion level may be greater than zero. In some examples, the first reference network performance test may be performed when at most a threshold quantity of UEs is connected to the node. In some examples, the threshold quantity of UEs is one (e.g., only one UE is connected to the node when the first reference network performance test is performed). The threshold quantity of UEs may be greater than one. In some examples, the first reference network performance test may be performed with at most a threshold quantity of Mobile Directory Numbers (MDNs) in a sector associated with the node (e.g., the threshold quantity of MDNs may be one or greater than one). In some examples, the first reference network performance test may be performed during a pre-production release stage of the node. In some examples, by performing the first reference network performance test (i) when the congestion level of the node does not meet (e.g., does not exceed) the threshold congestion level, (ii) when at most the threshold quantity of UEs is connected to the node, and/or (iii) during a pre-production release stage of the node, the first reference metric determined via the first reference network performance test may correspond to an ideal network performance metric (e.g., a network performance metric corresponding to ideal condition of the node). The first reference network performance test may be performed using a testing computer (e.g., the first testing computer 106 and/or the second testing computer 108). In some examples, the first reference network performance test is performed using one or more of the techniques provided herein with respect to performing the first set of network performance tests and/or the second set of network performance tests.

In some examples, a plurality of values of the first reference metric may be determined. A value of the plurality of values (e.g., each value of the plurality of values) may be associated with (i) a signal quality (e.g., an RF signal quality), which may be based upon a RSRP, a RSRQ, a CQI, a SINR, and/or one or more other signal quality metrics, (ii) a type of UE, (iii) a bandwidth (e.g., at least one of a DL bandwidth, a UL bandwidth, a UDP DL bandwidth, a UDP UL bandwidth, etc.), and/or (iv) one or more other characteristics. For example, a first value of the plurality of values may be associated with a first signal quality (e.g., a first RF signal quality), a first type of UE, and/or a first bandwidth. Alternatively and/or additionally, a second value of the plurality of values may be associated with a second signal quality (e.g., a second RF signal quality), a second type of UE, and/or a second bandwidth. In some examples, the first value may be determined via the first reference network performance test. The first reference network performance test may be performed using a UE (e.g., different than the UE 102) corresponding to the first type of UE (e.g., a first model, a first brand, etc.). The first reference network performance test may be associated with the first bandwidth (e.g., the node and/or the UE used in the first reference network performance test may be configured with the first bandwidth). The first reference network performance test may be associated with the first signal quality (e.g., the first signal quality may correspond to a quality of an RF connection between the node and the UE used in the first reference network performance test). In some examples, the second value may be determined via a second reference network performance test. The second reference network performance test may be performed using a UE (e.g., different than the UE 102) corresponding to the second type of UE (e.g., a second model, a second brand, etc.). The second reference network performance test may be associated with the second bandwidth (e.g., the node and/or the UE used in the second reference network performance test may be configured with the second bandwidth). The second reference network performance test may be associated with the second signal quality (e.g., the second signal quality may correspond to a quality of an RF connection between the node and the UE used in the second reference network performance test). In some examples, the first value of the first reference metric may be selected for comparison with a network performance metric of the first set of network performance metrics and/or the second set of network performance metrics based upon a determination that (i) the UE 102 is the first type of UE, (ii) a bandwidth (e.g., at least one of a DL bandwidth, a UL bandwidth, a UDP DL bandwidth, a UDP UL bandwidth, etc.) associated with the UE 102 (and/or the service plan) matches (e.g., is equal to and/or within a threshold range of) the first bandwidth, and/or (iii) a signal quality associated with the UE 102 (e.g., a quality of an RF connection between the UE 102 and the wireless communication site 116) matches (e.g., is equal to and/or within a threshold range of) the first signal quality. In some examples, one or more of the techniques provided herein with respect to determining the first reference metric may be used to determine one, some and/or all of the set of reference metrics.

In some examples, the first reference metric may be determined using a first reference metric determination function. In some examples, the first reference metric determination function may be used to determine the first reference metric using a bandwidth as input. The bandwidth may correspond to a DL bandwidth (e.g., a UDP DL bandwidth) and/or a UL bandwidth (e.g., a UDP UL bandwidth) associated with telecommunication service provided to the UE 102. In some examples, the bandwidth may be based upon one or more network performance metrics of the first set of network performance metrics (e.g., the DL network performance metric and/or the UL network performance metric). In some examples, the first reference metric determination function may be determined based upon test results of reference network performance tests (e.g., the first reference network performance test and/or other reference network performance tests) performed using different values of the bandwidth (e.g., a relationship between the bandwidth and the first reference metric may be derived from the test results).

In some examples, the set of reference metrics may comprise a threshold RF connection metric. In some examples, the threshold RF connection metric may be compared with the RF connection metric of the first set of network performance metrics associated with the first testing computer 106. In some examples, the network performance evaluation system 112 may determine that the first network performance issue is associated with (e.g., caused by and/or a symptom of) an RF connection condition (e.g., the network performance evaluation system 112 may isolate a problem area of the first network performance issue to the RF connection condition) based upon the RF connection metric not meeting (e.g., not exceeding) the threshold RF connection metric (e.g., the UL RF connection metric not meeting a threshold UL RF connection metric and/or the DL RF connection metric not meeting a threshold DL RF connection metric). In some examples, the RF connection condition may correspond to a poor wireless connection between the UE 102 and the wireless communication site 116 (e.g., at least one of signal loss, drops in connection, relatively low throughput, weak reception, etc.). For example, based upon the RF connection metric not meeting (e.g., not exceeding) the threshold RF connection metric, the network performance evaluation system 112 may automatically isolate a problem area associated with the first network performance issue to the RF connection condition (e.g., a wireless connection between the UE 102 and the wireless communication site 116). In some examples, based upon the first network performance issue being determined to be associated with the RF connection condition, the one or more corrective actions may comprise (i) providing instructions (using at least one of a text message, an email, a graphical interface, an audio message, etc.) to the UE 102 (and/or a user of the UE 102) to reposition the UE 102 from a first position to a second position with improved reception (e.g., improved wireless connection to the wireless communication site 116) compared to the first position, (ii) comprise allocating resources (e.g., increased resources), such as at least one of manpower, a maintenance device, energy (e.g., increased power for increased transmit power), one or more spectrums, equipment, one or more antennas, etc. to the wireless communication site 116 to increase signal quality for devices (e.g., UEs such as the UE 102) in communication with the wireless communication site 116, (iii) adjusting (e.g., automatically) one or more settings of the UE 102 (e.g., the one or more settings may be modified to match one or more settings of the wireless communication site 116 to provide for an improved wireless connection between the UE 102 and the wireless communication site 116), and/or (iv) providing the UE 102 with a configuration associated with the wireless communication site 116, wherein enabling the configuration enables the UE 102 to establish an improved wireless connection with the wireless communication site 116 (and/or one or more other wireless communication sites of the telecommunication service provider).

In some examples, the set of reference metrics may comprise a UL network performance metric threshold. In some examples, the UL network performance metric threshold may be determined based upon a reference UL network performance metric. The reference UL network performance metric may be determined via a reference UL network performance test (e.g., a reference UL UDP network performance test). In some examples, the reference UL network performance test may be performed using one or more of the techniques provided herein with respect to performing the first UL network performance test. The reference UL network performance metric may be determined using one or more of the techniques provided herein with respect to determining the first reference metric. The reference UL network performance test may be performed using one or more of the techniques provided herein with respect to performing the first reference network performance test. For example, the reference UL network performance test may be associated with a congestion level that does not meet the threshold congestion level. Alternatively and/or additionally, the reference UL network performance test may be performed using a wireless communication site that is connected to at most the threshold quantity of UEs. In some examples, the UL network performance metric threshold is determined by combining the reference UL network performance metric with a value (e.g., at least one of a metric, a factor, a percentage, etc.). In an example, the UL network performance metric is multiplied by a factor (e.g., a value between 0 and 1, such as a value between 0.2 and 0.8) to determine the UL network performance metric threshold. In an example in which the factor is 0.8, the UL network performance metric threshold may be equal to a product of the UL network performance metric and 0.8.

In some examples, the UL network performance metric threshold may be compared with the UL network performance metric (determined based upon the test result of the first UL network performance test, such as the UL UDP network performance test, for example) of the first set of network performance metrics associated with the first testing computer 106. In some examples, the reference UL network performance metric (and/or the UL network performance metric threshold) may be associated with (i) a signal quality (e.g., an RF signal quality), which may be based upon a RSRP, a RSRQ, a CQI, a SINR, and/or one or more other signal quality metrics, (ii) a type of UE, (iii) a bandwidth, and/or (iv) one or more other characteristics. In some examples, the UL network performance metric threshold may be selected (from among a plurality of UL network performance metric thresholds associated with various types of UEs, signal qualities, and/or bandwidths, for example) for comparison with the UL network performance metric based upon a determination that (i) the UE 102 is the type of UE associated with the reference UL network performance metric, (ii) a bandwidth (e.g., at least one of a DL bandwidth, a UL bandwidth, a UDP DL bandwidth, a UDP UL bandwidth, etc.) associated with the UE 102 (and/or the service plan) matches (e.g., is equal to and/or within a threshold range of) the bandwidth associated with the reference UL network performance metric, and/or (iii) a signal quality associated with the UE 102 (e.g., a quality of an RF connection between the UE 102 and the wireless communication site 116) matches (e.g., is equal to and/or within a threshold range of) the signal quality associated with the reference UL network performance metric. In some examples, the reference UL network performance metric (and/or the UL network performance metric threshold) may be determined based upon a bandwidth (e.g., at least one of a DL bandwidth, a UL bandwidth, a UDP DL bandwidth, a UDP UL bandwidth, etc.) and/or other characteristic associated with the UE 102 using a reference metric determination function (which may be determined and/or used using one or more of the techniques provided herein with respect to the first reference metric determination function).

In some examples, the network performance evaluation system 112 may determine that the first network performance issue is associated with (e.g., caused by and/or a symptom of) UL congestion, such as UL air interface congestion, associated with a wireless connection between the UE 102 and the wireless communication site 116 based upon the UL network performance metric not meeting (e.g., not exceeding) the UL network performance metric threshold (e.g., the network performance evaluation system 112 may isolate a problem area of the first network performance issue to the UL congestion). In an example, the UL network performance metric may correspond to a UL UDP speed of 5 Mbps and/or the UL network performance metric threshold may correspond to a threshold UL UDP speed of 10 Mbps, wherein a difference (e.g., 5 Mbps) between the UL UDP speed and the threshold UL UDP speed may be due to UL congestion (in the air interface, for example). In some examples, the threshold UL UDP speed (e.g., the UL network performance metric threshold) corresponds to a UL UDP speed that the UE 102 is capable of achieving (when the UL UDP speed is not impacted by network performance issues, for example), which may be determined based upon (i) a type of UE of the UE 102, (ii) a bandwidth associated with the UE 102 and/or the service plan, and/or (iii) a signal quality associated with the UE 102 (e.g., a quality of an RF connection between the UE 102 and the wireless communication site 116). In some examples, the UL congestion may be associated with (i) UEs (e.g., UEs that are in a single radio and/or are connected to the wireless communication site 116) exceeding a threshold quantity of UEs and/or (ii) UL traffic of the wireless communication site 116 exceeding a threshold amount of UL traffic (e.g., the threshold amount of UL traffic may be based upon a UL capacity of the wireless communication site 116). For example, the UEs and/or the traffic may overload a UL capacity of the wireless communication site 116, which may cause the UL UDP speed to be lower than the threshold UL UDP speed. For example, based upon the UL network performance metric not meeting the UL network performance metric threshold, the network performance evaluation system 112 may automatically isolate a problem area associated with the first network performance issue to a wireless connection between the UE 102 and the wireless communication site 116 (e.g., UL congestion in the wireless connection between the UE 102 and the wireless communication site 116). In some examples, based upon the first network performance issue being determined to be associated with the UL congestion (e.g., UL air interface congestion) between the UE 102 and the wireless communication site 116, the one or more corrective actions may comprise (i) allocating resources (e.g., increased resources), such as at least one of energy, one or more antennas, one or more spectrums, equipment, etc. to the wireless communication site 116 to relieve UL congestion associated with the wireless communication site 116, (ii) adjusting (e.g., automatically) one or more settings of the UE 102 (e.g., the one or more settings may be modified to match one or more settings of the wireless communication site 116 to provide for an improved wireless connection between the UE 102 and the wireless communication site 116), and/or (iii) providing the UE 102 with a configuration associated with the wireless communication site 116, wherein enabling the configuration enables the UE 102 to establish an improved wireless connection with the wireless communication site 116 (and/or one or more other wireless communication sites of the telecommunication service provider).

In some examples, the set of reference metrics may comprise a DL network performance metric threshold. In some examples, the DL network performance metric threshold may be determined based upon a reference DL network performance metric. The reference DL network performance metric may be determined via a reference DL network performance test (e.g., a reference DL UDP network performance test). In some examples, the reference DL network performance test may be performed using one or more of the techniques provided herein with respect to performing the first DL network performance test. The reference DL network performance metric may be determined using one or more of the techniques provided herein with respect to determining the first reference metric and/or the reference UL network performance metric. The reference DL network performance test may be performed using one or more of the techniques provided herein with respect to performing the first reference network performance test and/or the reference UL network performance test. For example, the reference DL network performance test may be (i) associated with a congestion level that does not meet the threshold congestion level and/or (ii) performed using a wireless communication site that is connected to at most the threshold quantity of UEs. In some examples, the DL network performance metric threshold is determined by combining the reference DL network performance metric with a value (e.g., at least one of a metric, a factor, a percentage, etc.).

In some examples, the DL network performance metric threshold may be compared with the DL network performance metric (determined based upon the test result of the first DL network performance test, such as the DL UDP network performance test, for example) of the first set of network performance metrics associated with the first testing computer 106. The DL network performance metric threshold (and/or the reference DL network performance metric) may be determined and/or compared with the DL network performance metric using one or more of the techniques provided herein with respect to determining the UL network performance metric threshold (and/or the reference UL network performance metric) and/or comparing the UL network performance metric threshold (and/or the reference UL network performance metric) with the UL network performance metric.

In some examples, the network performance evaluation system may determine that the first network performance issue is associated with (e.g., caused by and/or a symptom of) DL congestion (e.g., DL air interface congestion) associated with a wireless connection between the UE 102 and the wireless communication site 116 based upon the DL network performance metric not meeting (e.g., not exceeding) the DL network performance metric threshold (e.g., the network performance evaluation system 112 may isolate a problem area of the first network performance issue to the DL congestion). In an example, the DL network performance metric may correspond to a DL UDP speed of 50 Mbps and/or the DL network performance metric threshold may correspond to a threshold DL UDP speed of 100 Mbps, wherein a difference (e.g., 50 Mbps) between the DL UDP speed and the threshold DL UDP speed may be due to the DL congestion (in the air interface, for example). In some examples, the threshold DL UDP speed (e.g., the DL network performance metric threshold) corresponds to a DL UDP speed that the UE 102 is capable of achieving (when the DL UDP speed is not impacted by network performance issues, for example), which may be determined based upon (i) a type of UE of the UE 102, (ii) a bandwidth associated with the UE 102 and/or the service plan, and/or (iii) a signal quality associated with the UE 102 (e.g., a quality of an RF connection between the UE 102 and the wireless communication site 116). In some examples, the DL congestion may be associated with (i) UEs (e.g., UEs that are in a single radio and/or are connected to the wireless communication site 116) exceeding a threshold quantity of UEs and/or (ii) DL traffic of the wireless communication site 116 exceeding a threshold amount of DL traffic (e.g., the threshold amount of DL traffic may be based upon a DL capacity of the wireless communication site 116). For example, the UEs and/or the traffic may overload a DL capacity of the wireless communication site 116, which may cause the DL UDP speed to be lower than the threshold DL UDP speed. For example, based upon the DL network performance metric not meeting the DL network performance metric threshold, the network performance evaluation system 112 may automatically isolate a problem area associated with the first network performance issue to a wireless connection between the UE 102 and the wireless communication site 116 (e.g., DL congestion in the wireless connection between the UE 102 and the wireless communication site 116). In some examples, based upon the first network performance issue being determined to be associated with the DL congestion (e.g., DL air interface congestion) between the UE 102 and the wireless communication site 116, the one or more corrective actions may comprise (i) allocating resources (e.g., increased resources), such as at least one of energy, one or more antennas, one or more spectrums, equipment, etc. to the wireless communication site 116 to relieve DL congestion associated with the wireless communication site 116, (ii) adjusting (e.g., automatically) one or more settings of the UE 102 (e.g., the one or more settings may be modified to match one or more settings of the wireless communication site 116 to provide for an improved wireless connection between the UE 102 and the wireless communication site 116), and/or (iii) providing the UE 102 with a configuration associated with the wireless communication site 116, wherein enabling the configuration enables the UE 102 to establish an improved wireless connection with the wireless communication site 116 (and/or one or more other wireless communication sites of the telecommunication service provider).

In some examples, the set of reference metrics may comprise a first download network performance metric threshold (e.g., an internal download TCP network performance metric threshold) and/or a first round trip time threshold (e.g., an internal download round trip time threshold). In some examples, the first download network performance metric threshold may be determined based upon a first reference download network performance metric and/or the first round trip time threshold may be determined based upon a first reference round trip time metric. The first reference download network performance metric and/or the first reference round trip time metric may be determined via a first reference download network performance test (e.g., a reference internal download TCP network performance test). In some examples, the first reference download network performance test may be performed using one or more of the techniques provided herein with respect to performing the first download network performance test (e.g., the internal download TCP network performance test). The first reference download network performance metric and/or the first reference round trip time metric may be determined using one or more of the techniques provided herein with respect to determining the first reference metric, the first download network performance metric and/or the first download round trip time. The first reference download network performance test may be performed using one or more of the techniques provided herein with respect to performing the first reference network performance test. For example, the first reference download network performance test may be (i) associated with a congestion level that does not meet the threshold congestion level and/or (ii) performed using a wireless communication site that is connected to at most the threshold quantity of UEs. In some examples, the first download network performance metric threshold is determined by combining the first reference download network performance metric with a value (e.g., at least one of a metric, a factor, a percentage, etc.). In an example, the first reference download network performance metric may be indicative of (and/or based upon) a TCP maximum download performance (for a given DL bandwidth, such as a UDP DL bandwidth associated with the UE 102, for example).

In some examples, the first download network performance metric threshold may be compared with the first download network performance metric (determined based upon the test result of the first download network performance test, such as the internal download TCP network performance test, for example) of the first set of network performance metrics associated with the first testing computer 106. The first download network performance metric threshold (and/or the first reference download network performance metric) may be determined and/or compared with the first download network performance metric using one or more of the techniques provided herein with respect to determining the UL network performance metric threshold (and/or the reference UL network performance metric) and/or comparing the UL network performance metric threshold (and/or the reference UL network performance metric) with the UL network performance metric.

In some examples, the set of reference metrics may comprise a first upload network performance metric threshold (e.g., an internal upload TCP network performance metric threshold) and/or a second round trip time threshold (e.g., an internal upload round trip time threshold). In some examples, the first upload network performance metric threshold may be determined based upon a first reference upload network performance metric and/or the second round trip time threshold may be determined based upon a second reference round trip time metric. The first reference upload network performance metric and/or the second reference round trip time metric may be determined via a first reference upload network performance test (e.g., a reference internal upload TCP network performance test). In some examples, the first reference upload network performance test may be performed using one or more of the techniques provided herein with respect to performing the first upload network performance test (e.g., the internal upload TCP network performance test). The first reference upload network performance metric and/or the second reference round trip time metric may be determined using one or more of the techniques provided herein with respect to determining the first reference metric, the first upload network performance metric and/or the first upload round trip time. The first reference upload network performance test may be performed using one or more of the techniques provided herein with respect to performing the first reference network performance test. For example, the first reference upload network performance test may be (i) associated with a congestion level that does not meet the threshold congestion level and/or (ii) performed using a wireless communication site that is connected to at most the threshold quantity of UEs. In some examples, the first upload network performance metric threshold is determined by combining the first reference upload network performance metric with a value (e.g., at least one of a metric, a factor, a percentage, etc.). In an example, the first reference upload network performance metric may be indicative of (and/or based upon) a TCP maximum upload performance (for a given UL bandwidth, such as a UDP UL bandwidth associated with the UE 102, for example).

In some examples, the first upload network performance metric threshold may be compared with the first upload network performance metric (determined based upon the test result of the first upload network performance test, such as the internal upload TCP network performance test, for example) of the first set of network performance metrics associated with the first testing computer 106. The first upload network performance metric threshold (and/or the first reference upload network performance metric) may be determined and/or compared with the first upload network performance metric using one or more of the techniques provided herein with respect to determining the UL network performance metric threshold (and/or the reference UL network performance metric) and/or comparing the UL network performance metric threshold (and/or the reference UL network performance metric) with the UL network performance metric.

In some examples, the set of reference metrics may comprise a second download network performance metric threshold (e.g., an external download TCP network performance metric threshold) and/or a third round trip time threshold (e.g., an external download round trip time threshold). In some examples, the second download network performance metric threshold may be determined based upon a second reference download network performance metric and/or the third round trip time threshold may be determined based upon a third reference round trip time metric. The second reference download network performance metric and/or the third reference round trip time metric may be determined via a second reference download network performance test (e.g., a reference external download TCP network performance test). In some examples, the second reference download network performance test may be performed using one or more of the techniques provided herein with respect to performing the second download network performance test (e.g., the external download TCP network performance test). The second reference download network performance metric and/or the third reference round trip time metric may be determined using one or more of the techniques provided herein with respect to determining the first reference metric, the second download network performance metric and/or the second download round trip time. The second reference download network performance test may be performed using one or more of the techniques provided herein with respect to performing the first reference network performance test. For example, the second reference download network performance test may be (i) associated with a congestion level that does not meet the threshold congestion level and/or (ii) performed using a wireless communication site that is connected to at most the threshold quantity of UEs. In some examples, the second download network performance metric threshold is determined by combining the second reference download network performance metric with a value (e.g., at least one of a metric, a factor, a percentage, etc.). In an example, the second reference download network performance metric may be indicative of (and/or based upon) a TCP maximum download performance (for a given DL bandwidth, such as a UDP DL bandwidth associated with the UE 102, for example).

Alternatively and/or additionally, the second download network performance metric threshold may be determined based upon the first download network performance metric (e.g., the internal download TCP network performance metric determined via the internal download TCP network performance test). In some examples, the second download network performance metric threshold is determined by combining the first download network performance metric with a value (e.g., at least one of a metric, a factor, a percentage, etc.).

In some examples, the second download network performance metric threshold may be compared with the second download network performance metric (determined based upon the test result of the second download network performance test, such as the external download TCP network performance test, for example) of the second set of network performance metrics associated with the second testing computer 108. The second download network performance metric threshold (and/or the second reference download network performance metric) may be determined and/or compared with the second download network performance metric using one or more of the techniques provided herein with respect to determining the UL network performance metric threshold (and/or the reference UL network performance metric) and/or comparing the UL network performance metric threshold (and/or the reference UL network performance metric) with the UL network performance metric. In some examples, the set of reference metrics may comprise a second upload network performance metric threshold (e.g., an external upload TCP network performance metric threshold) and/or a fourth round trip time threshold (e.g., an external upload round trip time threshold). In some examples, the second upload network performance metric threshold may be determined based upon a second reference upload network performance metric and/or the fourth round trip time threshold may be determined based upon a fourth reference round trip time metric. The second reference upload network performance metric and/or the fourth reference round trip time metric may be determined via a second reference upload network performance test (e.g., a reference external upload TCP network performance test). In some examples, the second reference upload network performance test may be performed using one or more of the techniques provided herein with respect to performing the second upload network performance test (e.g., the external upload TCP network performance test). The second reference upload network performance metric and/or the fourth reference round trip time metric may be determined using one or more of the techniques provided herein with respect to determining the first reference metric, the second upload network performance metric and/or the second upload round trip time. The second reference upload network performance test may be performed using one or more of the techniques provided herein with respect to performing the first reference network performance test. For example, the second reference upload network performance test may be (i) associated with a congestion level that does not meet the threshold congestion level and/or (ii) performed using a wireless communication site that is connected to at most the threshold quantity of UEs. In some examples, the second upload network performance metric threshold is determined by combining the second reference upload network performance metric with a value (e.g., at least one of a metric, a factor, a percentage, etc.). In an example, the second reference upload network performance metric may be indicative of (and/or based upon) a TCP maximum download performance (for a given UL bandwidth, such as a UDP UL bandwidth associated with the UE 102, for example).

Alternatively and/or additionally, the second upload network performance metric threshold may be determined based upon the first upload network performance metric (e.g., the internal upload TCP network performance metric determined via the internal upload TCP network performance test). In some examples, the second upload network performance metric threshold is determined by combining the first upload network performance metric with a value (e.g., at least one of a metric, a factor, a percentage, etc.).

In some examples, the second upload network performance metric threshold may be compared with the second upload network performance metric (determined based upon the test result of the second upload network performance test, such as the external upload TCP network performance test, for example) of the second set of network performance metrics associated with the second testing computer 108. The second upload network performance metric threshold (and/or the second reference upload network performance metric) may be determined and/or compared with the second upload network performance metric using one or more of the techniques provided herein with respect to determining the UL network performance metric threshold (and/or the reference UL network performance metric) and/or comparing the UL network performance metric threshold (and/or the reference UL network performance metric) with the UL network performance metric.

In some examples, the network performance evaluation system 112 may determine that the first network performance issue is associated with a UL bandwidth condition (e.g., a UL air interface bandwidth bottleneck) associated with a wireless connection between the UE 102 and the wireless communication site 116 based upon (i) the first download network performance metric (e.g., the internal download TCP network performance metric) not meeting (e.g., not exceeding) the first download network performance metric threshold, (ii) the first download round trip time not meeting (e.g., not exceeding) the first round trip time threshold and/or (iii) the UL network performance metric (determined based upon the test result of the first UL network performance test, for example) not meeting (e.g., not exceeding) a second UL network performance metric threshold of the set of reference metrics. For example, based upon the first download network performance metric not meeting the first download network performance metric threshold, the network performance evaluation system 112 may automatically isolate a problem area associated with the first network performance issue to the wireless communication site 116 and/or a wireless connection between the UE 102 and the wireless communication site 116 (e.g., UL air interface bandwidth bottleneck).

The second UL network performance metric threshold may correspond to (and/or may be based upon) a minimum UL network performance metric (e.g., minimum UL speed) required to achieve a download speed (e.g., the first download network performance metric) that meets a download speed threshold (e.g., the first download network performance metric threshold). Alternatively and/or additionally, the first round trip time threshold may correspond to (and/or may be based upon) a minimum round trip time needed for achieving a download speed (e.g., the first download network performance metric) that meets the download speed threshold. Accordingly, in some examples, a determination that (i) the UL network performance metric does not meet the second UL network performance metric threshold and/or (ii) the first download round trip time does not meet the first round trip time threshold may be reflective of there being a bandwidth condition in which the wireless communication site 116 and/or the wireless connection between the UE 102 and the wireless communication site 116 have lower than a threshold amount of bandwidth (e.g., the wireless communication site 116 and/or the wireless connection do not have enough available bandwidth to ensure that all data packets transmitted by UEs connected to the wireless communication site 116 reach their destination in a timely manner). In some examples, the second UL network performance metric threshold may be determined using one or more of the techniques provided herein with respect to determining the first reference metric and/or the UL network performance metric threshold.

In some examples, the network performance evaluation system 112 may determine that the first network performance issue is associated with (e.g., caused by and/or a symptom of) first congestion associated with the core network 118 (e.g., the network performance evaluation system 112 may isolate a problem area of the first network performance issue to the first congestion) based upon (i) the first download network performance metric (e.g., the internal download TCP network performance metric) not meeting (e.g., not exceeding) the first download network performance metric threshold, (ii) the first download round trip time meeting (e.g., exceeding) the first round trip time threshold and/or (iii) the UL network performance metric meeting (e.g., exceeding) the second UL network performance metric threshold. In some examples, a determination that (i) the UL network performance metric meets the second UL network performance metric threshold and/or (ii) the first download round trip time meets the first round trip time threshold may be reflective of (A) a UL bandwidth associated with the wireless communication site 116 not being a constraining factor on the first download network performance metric, and/or (B) download performance of the first download network performance test being impacted by the first congestion (in the network 104, for example). In some examples, the first congestion may correspond to network congestion (e.g., DL direction congestion) associated with a connection (of the one or more connections 122, for example) between the core network 118 and the first wireless communication site 116 (e.g., congestion from the core network 118 to the first wireless communication site 116). Thus, in accordance with some embodiments, the network performance evaluation system 112 may automatically isolate a problem area associated with the first network performance issue to the core network 118 and/or a connection between the core network 118 and the first wireless communication site 116 (e.g., congestion from the core network 118 to the first wireless communication site 116).

In some examples, the network performance evaluation system 112 may determine that the first network performance issue is associated with (e.g., caused by and/or a symptom of) second congestion associated with the core network 118 based upon the first upload network performance metric (e.g., the internal upload TCP network performance metric) not meeting (e.g., not exceeding) the first upload network performance metric threshold (e.g., the network performance evaluation system 112 may isolate a problem area of the first network performance issue to the second congestion). In some examples, a determination that the first upload network performance metric does not meet the first upload network performance metric threshold may be reflective of upload performance of the first upload network performance test (e.g., the internal upload TCP network performance test) being impacted by the second congestion (in the network 104, for example). In some examples, the second congestion may correspond to network congestion (e.g., UL direction congestion) associated with a connection (of the one or more connections 122, for example) between the core network 118 and the first wireless communication site 116 (e.g., congestion from the first wireless communication site 116 to the core network 118). Thus, in accordance with some embodiments, the network performance evaluation system 112 may automatically isolate a problem area associated with the first network performance issue to the core network 118 and/or a connection between the core network 118 and the first wireless communication site 116 (e.g., congestion from the first wireless communication site 116 to the core network 118).

In some examples, the network performance evaluation system 112 may determine that the first network performance issue is associated with (e.g., caused by and/or a symptom of) third congestion (associated with the public network 110, for example) based upon the second download network performance metric (e.g., the external download TCP network performance metric) not meeting (e.g., not exceeding) the second download network performance metric threshold (e.g., the external download TCP network performance metric threshold). For example, the network performance evaluation system 112 may isolate a problem area of the first network performance issue to the third congestion. In some examples, a determination that the second download network performance metric does not meet the second download network performance metric threshold may be reflective of download performance of the second download network performance test (e.g., the external download TCP network performance test) being impacted by the third congestion (in the public network 110, for example). In some examples, the third congestion may correspond to network congestion associated with a connection, over the public network 110 (e.g., the Internet), between the core network 118 and the second testing computer 108. In some examples, the third congestion may correspond to Internet congestion. Internet congestion may be associated with one or more resources (e.g., servers, network components, etc.) of the Internet having traffic (e.g., data packet traffic) exceeding a threshold level of traffic (e.g., the one or more resources are not able to process and/or transmit data packets in a timely manner due to the traffic of the one or more resources exceeding the threshold level of traffic), which may result in at least one of more delays, relatively lower data transfer speeds, etc. for components utilizing the one or more resources for Internet communication. In some examples, the third congestion may correspond to network congestion associated with a connection (of the one or more connections 124, for example) between the core network 118 and the public network 110 (e.g., the Internet). Thus, in accordance with some embodiments, the network performance evaluation system 112 may automatically isolate a problem area associated with the first network performance issue to the public network 110 and/or a connection between the second testing computer 108 and the core network 118 (and/or a connection between the second testing computer 108 and the network 104).

In some examples, the network performance evaluation system 112 may determine that the first network performance issue is associated with (e.g., caused by and/or a symptom of) fourth congestion (associated with the public network 110, for example) based upon the second upload network performance metric (e.g., the external upload TCP network performance metric) not meeting (e.g., not exceeding) the second upload network performance metric threshold (e.g., the external upload TCP network performance metric threshold). For example, the network performance evaluation system 112 may isolate a problem area of the first network performance issue to the fourth congestion. In some examples, a determination that the second upload network performance metric does not meet the second upload network performance metric threshold may be reflective of upload performance of the second upload network performance test (e.g., the external upload TCP network performance test) being impacted by the fourth congestion (in the public network 110, for example). In some examples, the fourth congestion may correspond to network congestion associated with a connection, over the public network 110 (e.g., the Internet), between the core network 118 and the second testing computer 108. In some examples, the fourth congestion may correspond to Internet congestion. In some examples, the fourth congestion may correspond to network congestion associated with a connection (of the one or more connections 124, for example) between the core network 118 and the public network 110 (e.g., the Internet). Thus, in accordance with some embodiments, the network performance evaluation system 112 may isolate (e.g., automatically isolate) a problem area associated with the first network performance issue to the public network 110 and/or a connection between the second testing computer 108 and the core network 118 (and/or a connection between the second testing computer 108 and the network 104).

In accordance with some embodiments of the present disclosure, the network performance evaluation system 112 may isolate (e.g., automatically isolate) a problem area associated with the first network performance issue to a region of interest (e.g., a network segment corresponding to one or more components). For example, the region of interest may correspond to at least one of the UE 102 (e.g., a RF environment of the UE 102 may be unsuitable), the wireless communication site 116 (e.g., the wireless communication site 116 may have congestion and/or bandwidth bottleneck), the core network 118 (e.g., the core network 118 may have congestion and/or bandwidth bottleneck), the public network 110 (e.g., congestion in the public network 110, such as Internet congestion), etc. In some examples, the one or more corrective actions may comprise one or more actions to improve network performance associated with one or more components of the region of interest (e.g., at least one of the UE 102, the wireless communication site 116, the core network 118, the public network 110, etc.). For example, the one or more corrective actions may comprise (i) modifying network resources associated with a component of the region of interest (e.g., allocating a new set of network resources for use by the component), (ii) switching a network slice assigned to a component of the region of interest (e.g., switching a network slice assigned to the component from a first network slice to a second network slice), (iii) modifying one or more Quality of Service (QOS) parameters associated with a component of the region of interest (e.g., increasing QoS level assigned to the component), (iv) modifying a priority of traffic of a component of the region of interest (e.g., increasing a priority of traffic of the component to prioritize the traffic over other traffic), and/or (v) one or more other actions. Accordingly, in some examples, the one or more corrective actions may improve network performance of the component, and thus may solve the first network performance issue.

Alternatively and/or additionally, in response to identifying the region of interest of the first network performance issue, the network performance evaluation system 112 may (i) deploy one or more resources to one or more components (e.g., malfunctioning components) of the region of interest, (ii) reconfigure, repair and/or replace one or more components (e.g., malfunctioning components) of the region of interest, (iii) perform a software update for one or more components (e.g., malfunctioning components) of the region of interest, and/or (iv) transmit information, associated with one or more components of the region of interest, to a network maintenance device associated with a network maintenance agent (e.g., a person, a robot, etc. tasked with repairing and/or performing maintenance for network malfunctioning network components). The network maintenance agent may use the information to repair, reconfigure and/or replace one or more malfunctioning components of the region of interest.

In some examples, the network performance evaluation system 112 may transmit an indication of the first network performance issue to a network management device associated with a network management agent. The indication of the first network performance issue may be indicative of (i) the region of interest, (ii) a type of network performance issue of the first network performance issue (e.g., whether the first network performance issue is associated with at least one of internal bandwidth of the telecommunication service provider, an RF condition of a UE, etc.), (iii) a location of one or more components of the region of interest, (iv) one or more metrics of the first set of network performance metrics, (v) one or more metrics of the second set of network performance metrics and/or (vi) other information associated with the first network performance issue.

In some examples, the network performance evaluation system 112 may isolate a problem area associated with the first network performance issue to a first region of interest associated with the internal network based upon a first network performance metric of the first set of network performance metrics not meeting (e.g., not exceeding) a first network performance metric threshold of the one or more reference metrics. Alternatively and/or additionally, the network performance evaluation system 112 may isolate the problem area associated with the first network performance issue to a second region of interest associated with the public network based upon (i) the first network performance metric of the first set of network performance metrics meeting (e.g., exceeding) the first network performance metric threshold of the one or more reference metrics and/or (ii) a second network performance metric of the second set of network performance metrics not meeting (e.g., not exceeding) a second network performance threshold of the one or more reference metrics. In an example, a user of the UE 102 (e.g., the user may be a customer of the telecommunication service provider) may have (previously) initiated an (external) speed test which may provide a test result indicating a network performance metric (e.g., data transfer speed) lower than a threshold metric (e.g., a minimum data transfer speed indicated by the service plan associated with the UE 102, for example). The user may submit a service request based upon the test result (e.g., the service request may correspond to a complaint that service provided by the telecommunication service provider is too slow). Based on the problem area being isolated to the second region of interest (associate with the public network, for example), the network performance evaluation system 112 may provide an indication informing a service agent associated with the telecommunication service provider and/or the user (e.g., the customer) that the first network performance issue is not caused by the telecommunication service provider, but is actually caused by a problem with the public network (e.g., the Internet).

In some examples, one or more of the techniques provided herein may be performed to identify and/or isolate a network performance issue associated with a UE without requiring special privileges and/or access to private and/or secured resources, thereby enabling the network performance evaluation system 112 to automatically determine the network performance issue in a secure manner.

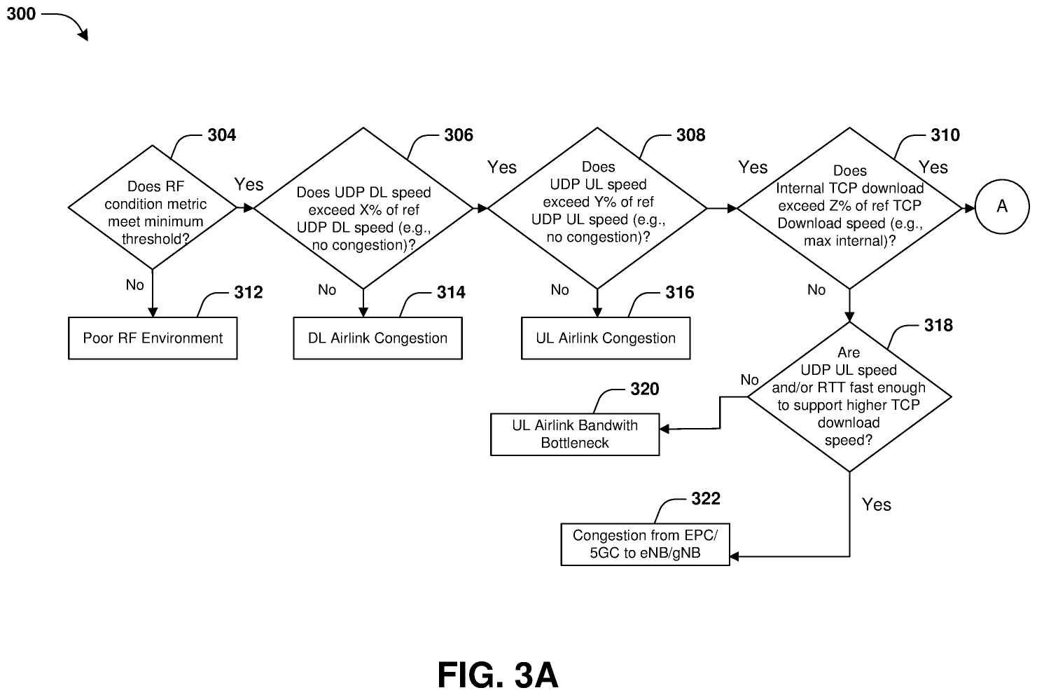

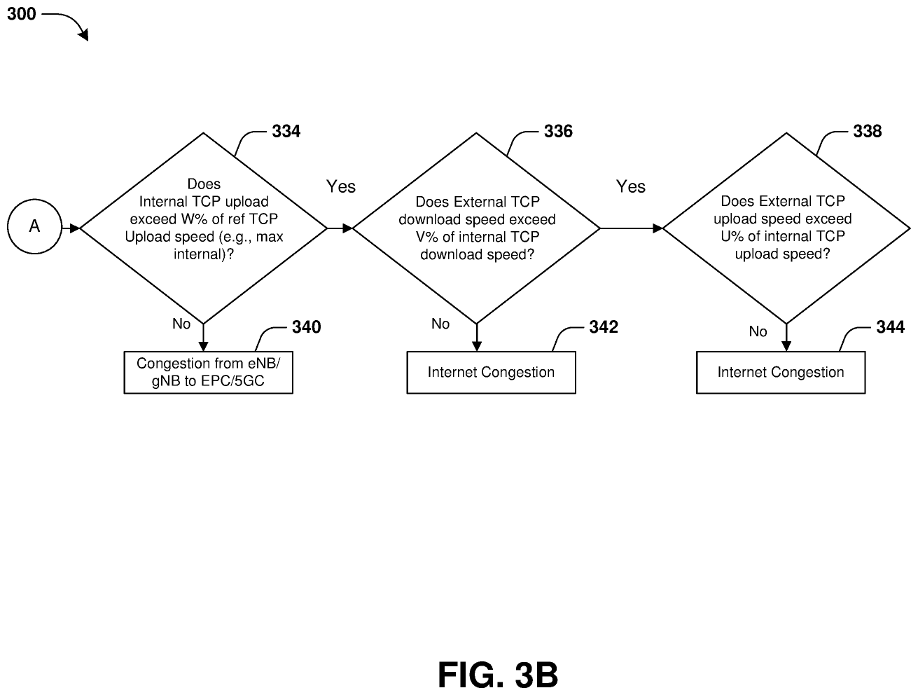

An embodiment of determining the first network performance issue based upon the first set of network performance metrics, the second set of network performance metrics and/or the set of reference metrics is illustrated by an exemplary method 300 of FIGS. 3A-3B, described in conjunction with FIGS. 1A-1B. In some examples, point A in FIG. 3A connects to point A in FIG. 3B.

At 304 (shown in FIG. 3A), the network performance evaluation system 112 may determine whether an RF condition metric (e.g., at least one of the RF connection metric, the DL RF connection metric, the UL RF connection metric, etc.) meets a minimum threshold (e.g., at least one of the threshold RF connection metric, the threshold DL RF connection metric, the threshold UL RF connection metric, etc.). Based upon a determination that the RF condition metric does not meet the minimum threshold, the network performance evaluation system 112 may determine at 312 that the first network performance issue is associated with (e.g., caused by and/or a symptom of) a poor RF environment associated with the UE 102 and/or the wireless communication site 116.

At 306, the network performance evaluation system 112 may determine whether a UDP DL speed (e.g., the DL network performance metric) exceeds X % of a reference UDP DL speed (e.g., the reference DL network performance metric). Act 306 may be performed in response to determining (at act 304, for example) that the RF condition metric meets the minimum threshold. Based upon a determination that the UDP DL speed does not exceed a specified percentage of the reference UDP DL speed, the network performance evaluation system 112 may determine 314 that the first network performance issue is associated with (e.g., caused by and/or a symptom of) DL air interface congestion. In an example in which the specified percentage is 80%, the reference UDP DL speed may correspond to 80% of the reference UDP DL speed.

At 308, the network performance evaluation system 112 may determine whether a UDP UL speed (e.g., the UL network performance metric) exceeds Y % of a reference UDP UL speed (e.g., the reference UL network performance metric). Act 308 may be performed in response to determining (at act 306, for example) that the UDP DL speed exceeds X % of the reference UDP DL speed. Based upon a determination that the UDP UL speed does not exceed Y % of the reference UDP UL speed, the network performance evaluation system 112 may determine 316 that the first network performance issue is associated with (e.g., caused by and/or a symptom of) UL air interface congestion.

At 310, the network performance evaluation system 112 may determine whether an internal TCP download speed (e.g., the first download network performance metric) exceeds Z % of a reference TCP download speed (e.g., the first reference download network performance metric). In some examples, the reference TCP download speed may correspond to a maximum internal TCP download speed associated with the wireless communication site 116 and/or the first testing computer 106. Act 310 may be performed in response to determining (at act 308, for example) that the UDP UL speed exceeds Y % of the reference UDP UL speed. Based upon a determination that the internal TCP download speed does not exceed Z % of the reference TCP download speed, the network performance evaluation system 112 may determine 318 whether the UDP UL speed and/or a round trip time metric (e.g., the first download round trip time) are sufficient to support increased TCP download speeds (compared to the internal TCP download speed, for example). In some examples, based upon a determination that the UDP UL speed and/or the round trip time metric are not sufficient to support increased TCP download speeds (e.g., a determination that the first download round trip time does not meet the first round trip time threshold and/or that the UL network performance metric does not meet the second UL network performance metric threshold), the network performance evaluation system 112 may determine 320 that the first network performance issue is associated with (e.g., caused by and/or a symptom of) UL air interface bandwidth bottleneck. In some examples, based upon a determination that the UDP UL speed and/or the round trip time metric are sufficient to support increased TCP download speeds (e.g., a determination that the first download round trip time meets the first round trip time threshold and/or that the UL network performance metric meets the second UL network performance metric threshold), the network performance evaluation system 112 may determine 322 that the first network performance issue is associated with (e.g., caused by and/or a symptom of) congestion from the core network 118 to the wireless communication site 116.

At 334 (shown in FIG. 3B), the network performance evaluation system 112 may determine whether an internal TCP upload speed (e.g., the first upload network performance metric) exceeds W % of a reference TCP upload speed (e.g., the first reference upload network performance metric). In some examples, the reference TCP upload speed may correspond to a maximum internal TCP upload speed associated with the wireless communication site 116 and/or the first testing computer 106. Act 334 may be performed in response to determining (at act 310, for example) that the internal TCP download speed exceeds Z % of the reference TCP download speed. Based upon a determination that the internal TCP upload speed does not exceed W % of the reference TCP upload speed, the network performance evaluation system 112 may determine 340 that the first network performance issue is associated with (e.g., caused by and/or a symptom of) congestion from the wireless communication site 116 to the core network 118.

At 336, the network performance evaluation system 112 may determine whether an external TCP download speed (e.g., the second download network performance metric) exceeds V % of the internal TCP download speed (e.g., the first download network performance metric). Act 336 may be performed in response to determining (at act 334, for example) that the internal TCP upload speed exceeds W % of the reference TCP upload speed. Based upon a determination that the external TCP download speed does not exceed V % of the internal TCP download speed, the network performance evaluation system 112 may determine 342 that the first network performance issue is associated with (e.g., caused by and/or a symptom of) internet congestion.

At 338, the network performance evaluation system 112 may determine whether an external TCP upload speed (e.g., the second upload network performance metric) exceeds U % of the internal TCP upload speed (e.g., the first upload network performance metric). Act 338 may be performed in response to determining (at act 336, for example) that the external TCP download speed exceeds V % of the internal TCP download speed. Based upon a determination that the external TCP upload speed does not exceed U % of the internal TCP upload speed, the network performance evaluation system 112 may determine 344 that the first network performance issue is associated with (e.g., caused by and/or a symptom of) internet congestion.

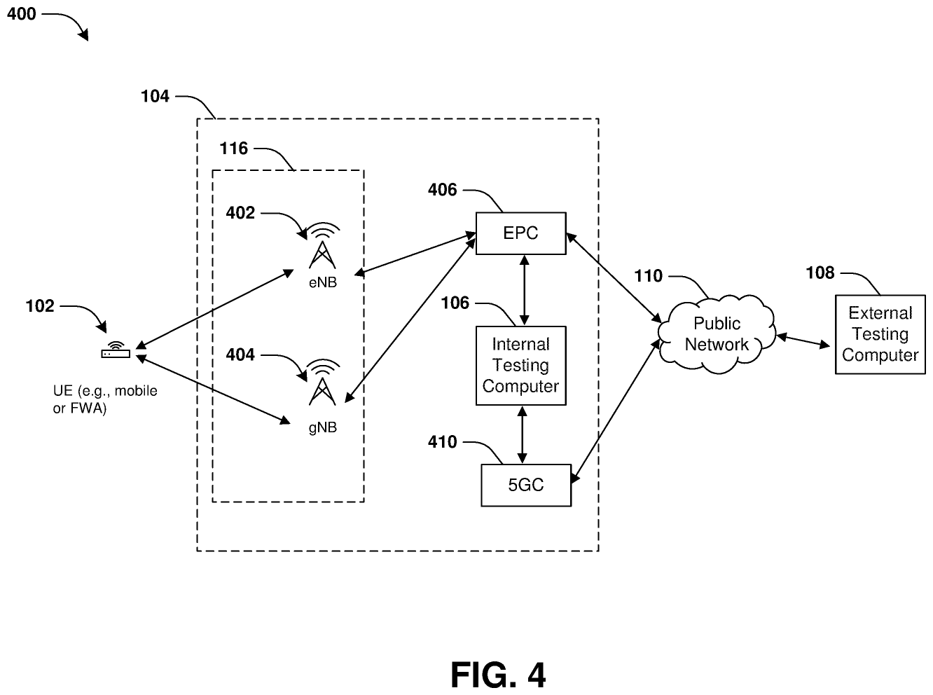

FIG. 4 illustrates a first network diagram 400 associated with the system 101. In some examples, the first network diagram 400 corresponds to a 5G non-standalone (5G NSA) implementation. In some examples, the UE 102 may be connected to an e-NodeB (eNB) 402 and/or a g-NodeB (gNB) 404. In some examples, the wireless communication site 116 comprises the eNB 402 and/or the gNB 404. In some examples, the UE 102 may be connected to the eNB 402 and/or the gNB 404 (e.g., the UE 102 may concurrently connected to the eNB 402 and the gNB 404). In some examples, the network 104 may comprise an Evolved Packet Core (EPC) component 406 and/or a 5G Core Network (5GC) component 410. For example, the core network 118 may comprise the EPC component 406 and/or the 5GC component 410. In some examples, in the 5G non-standalone implementation, data transfer of a network performance test associated with the first testing computer 106 may be performed over (i) one or more connections between the UE 102 and the eNB 402 and/or the gNB 404, (ii) one or more connections between the EPC component 406 and the eNB 402 and/or the gNB 404, and/or (iii) one or more connections between the EPC component 406 and the first testing computer 106. In some examples, in the 5G non-standalone implementation, data transfer of a network performance test associated with the second testing computer 108 may be performed over (i) one or more connections between the UE 102 and the eNB 402 and/or the gNB 404, (ii) one or more connections between the EPC component 406 and the eNB 402 and/or the gNB 404, and/or (iii) one or more connections, over the public network 110 (e.g., the Internet), between the EPC component 406 and the second testing computer 108.

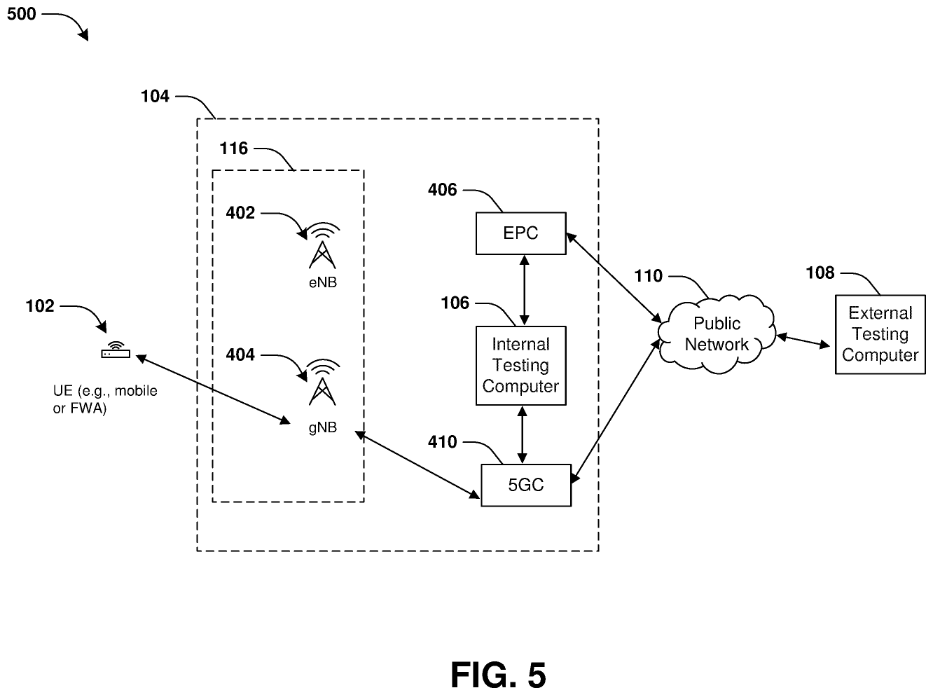

FIG. 5 illustrates a second network diagram 500 associated with the system 101. In some examples, the second network diagram 500 corresponds to a 5G standalone (5G SA) implementation. In some examples, the UE 102 may be connected to the gNB 404 (while the UE 102 is not connected to the eNB 402, for example). In some examples, in the 5G standalone implementation, data transfer of a network performance test associated with the first testing computer 106 may be performed over (i) one or more connections between the UE 102 and the gNB 404, (ii) one or more connections between the EPC component 406 and the gNB 404, and/or (iii) one or more connections between the EPC component 406 and the first testing computer 106. In some examples, in the 5G standalone implementation, data transfer of a network performance test associated with the second testing computer 108 may be performed over (i) one or more connections between the UE 102 and the gNB 404, (ii) one or more connections between the EPC component 406 and the gNB 404, and/or (iii) one or more connections, over the public network 110 (e.g., the Internet), between the EPC component 406 and the second testing computer 108.

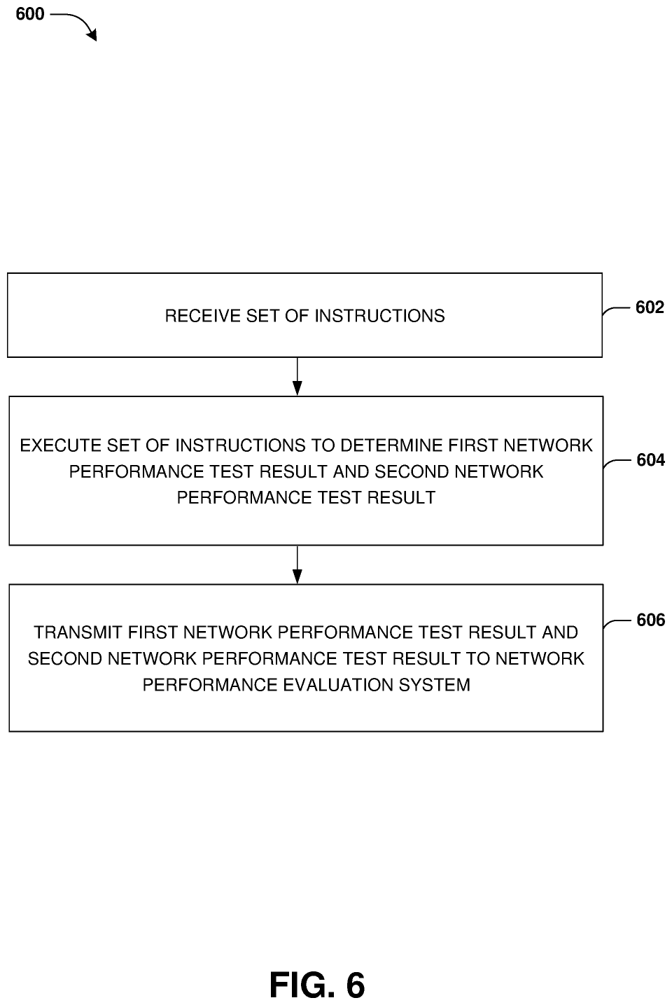

An embodiment of determining network performance test results using the UE 102 is illustrated by an example method 600 of FIG. 6, and is further described in conjunction with FIGS. 1A-1B.

At 602, the UE 102 may receive a set of instructions. For example, the set of instructions may be received from a network performance evaluation system. In some examples, a network performance inquiry may be initiated by a user of the UE 102 and/or a service agent associated with the telecommunication service provider. For example, the network performance inquiry may be initiated due to a (perceived) telecommunication service problem impacting service provided to the UE 102 (e.g., the user may encounter internet service problems). The network performance inquiry may be initiated in response to a request from the user. The request may be received via an interface displayed via the UE 102. Alternatively and/or additionally, the user may verbally announce a desire to initiate the network performance inquiry (in a conversation with the service agent, for example). In some examples, the set of instructions may be provided to the UE 102 in response to initiating the network performance inquiry. In some examples, the UE 102 may receive a web address. The set of instructions may be downloaded to the UE 102 and/or executed by the UE 102 in response to a selection of the web address (and/or in response to the UE 102 accessing an internet resource corresponding to the web address). Alternatively and/or additionally, the set of instructions may be downloaded to the UE 102 and/or executed by the UE 102 using the network evaluation application (installed on the UE 102, for example).

At 604, the UE 102 may execute the set of instructions to determine a first network performance test result (e.g., one or more network performance test result of the first set of test results) and/or a second network performance test result (e.g., one or more network performance test result of the second set of test results). For example, the UE 102 may perform first communication with the first testing computer 106 and/or derive the first network performance test result based upon the first communication. Alternatively and/or additionally, the UE 102 may perform second communication with the second testing computer 108 and/or derive the second network performance test result based upon the second communication.

At 606, the UE 102 may transmit the first network performance test result and/or the second network performance test result to the network performance evaluation system 112. The network performance evaluation system 112 may use the first network performance test result and/or the second network performance test result (in conjunction with the set of reference metrics, for example) to determine (e.g., isolate) the first network performance issue.

In some examples, the UE 102 may use one or more of the techniques provided herein to trigger and/or perform a first evaluation process comprising one or more first actions (i) performing the first set of network performance tests with the first testing computer 106 to derive the first set of test results, (ii) performing the second set of network performance tests with the second testing computer 108 to derive the second set of test results, (iii) determining the first set of network performance metrics based upon the first set of test results, (iv) determining the second set of network performance metrics based upon the second set of test results, (v) determining, based upon the first set of network performance metrics and/or the second set of network performance metrics, whether or not there is a network performance issue (e.g., the first network performance issue) associated with the UE 102, (vi) isolating the network performance issue to a region of interest (e.g., a network segment), and/or (vii) reporting determined information to the network performance evaluation system 112 and/or other component (e.g., the determined information may be indicative of at least one of the first set of test results, the second set of test results, the first set of network performance metrics, the second set of network performance metrics, the identified network performance issue, the region of interest associated with the network performance issue, etc.).

In some examples, the UE 102 may perform evaluation processes at regular and/or irregular intervals (using one or more of the techniques provided herein with respect to performing the first evaluation process, for example). In some examples, timing of the evaluation processes may be configured by the evaluation configuration (e.g., the UE 102 may trigger evaluation processes at times configured by the evaluation configuration). Network performance associated with the UE 102 and/or the wireless communication site 116 may be monitored based upon results (e.g., network performance metrics, identified network performance issues, regions of interest, etc.) of the evaluation processes. In some examples, one or more corrective actions may be performed in response to detecting a network performance issue via an evaluation process performed using the UE 102 (e.g., one or more resources, such as one or more spectrums, etc. may be provisioned and/or allocated to one or more network components, such as the wireless communication site 116, to address the network performance issue).

In some examples, a plurality of UEs may be configured to perform evaluation processes (using one or more of the techniques provided herein with respect to the UE 102, for example). In some examples, the network performance evaluation system 112 may provide the plurality of UEs with the evaluation configuration. The plurality of UEs may perform evaluation processes at regular and/or irregular intervals (using the evaluation configuration, for example). The network performance evaluation system 112 may receive reported information from the plurality of UEs and/or may monitor network performance of network components based upon the reported information. The network performance evaluation system 112 may perform one or more corrective actions in response to detecting a network performance issue. In some examples, the plurality of UEs comprise UEs in a geographical region with a plurality of sites (e.g., wireless communication sites) of the telecommunication service provider (and/or other telecommunication service providers), and/or the network performance evaluation system 112 monitors the reported information from the plurality of UEs to monitor network performance of the plurality of sites. The network performance evaluation system 112 may perform one or more corrective actions associated with a site of the plurality of sites in response to detecting a network performance issue associated with the site.

In some examples, one, some and/or all of the operations provided herein with respect to the UE 102 may be performed by the network performance evaluation system 112. In some examples, one, some and/or all of the operations provided herein with respect to the network performance evaluation system 112 may be performed by the UE 102.

Embodiments are contemplated in which the UE 102 interacts with merely a single testing computer (e.g., the first testing computer 106 or the second testing computer 108) to derive a set of test results (e.g., the first set of test results or the second set of test results), and/or the network performance evaluation system 112 may determine the first network performance issue based upon the (derived) set of test results. Embodiments are contemplated in which the first network performance issue is determined using the UE 102.

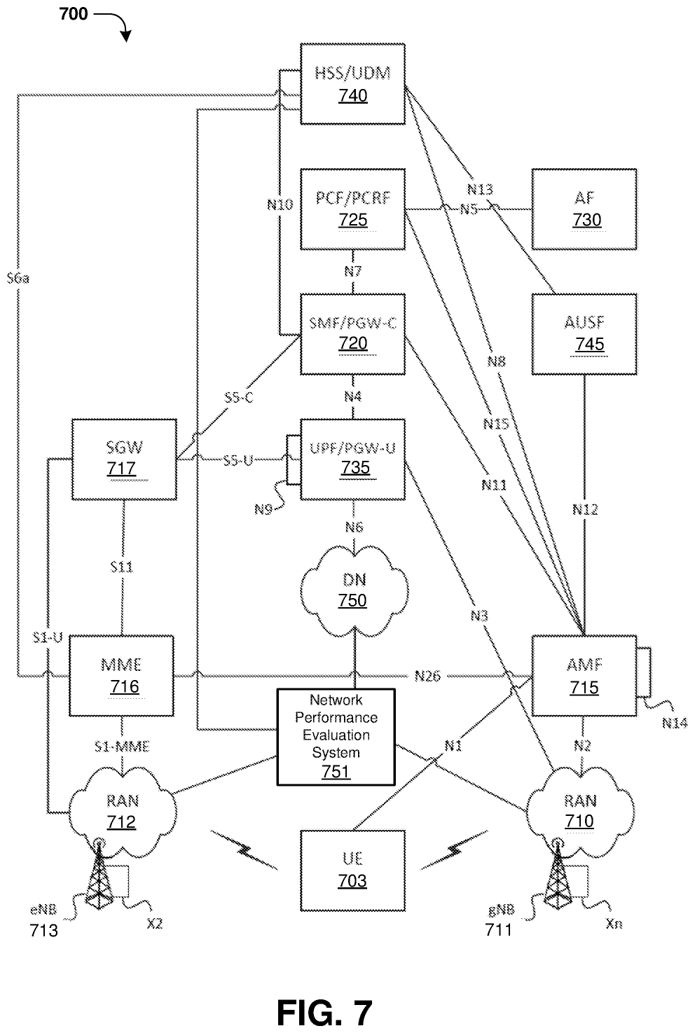

FIG. 7 illustrates an example environment 700, in which one or more embodiments may be implemented. In some embodiments, environment 700 may correspond to a Fifth Generation (“5G”) network, and/or may include elements of a 5G network. In some embodiments, the private network 104 and/or a private network site of the private network 104 (e.g., each private network site of one, some and/or all of the plurality of private network sites of the private network 104) may be implemented using techniques, configurations and/or components shown in and/or described with respect to FIG. 7. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 700 may include UE 703, RAN 710 (which may include one or more Next Generation Node Bs (“gNBs”) 711), RAN 712 (which may include one or more one or more evolved Node Bs (“eNBs”) 713), and various network functions such as Access and Mobility Management Function (“AMF”) 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Home Subscriber Server (“HSS”)/Unified Data Management (“UDM”) 740, and Authentication Server Function (“AUSF”) 745. Environment 700 may also include one or more networks, such as Data Network (“DN”) 750. Environment 700 may include one or more additional devices or systems communicatively coupled to one or more networks (e.g., DN 750), such as network performance evaluation system 751.

The example shown in FIG. 7 illustrates one instance of each network component or function (e.g., one instance of SMF/PGW-C 720, PCF/PCRF 725, UPF/PGW-U 735, HSS/UDM 740, and/or 745). In practice, environment 700 may include multiple instances of such components or functions. For example, in some embodiments, environment 700 may include multiple “slices” of a core network, where each slice includes a discrete set of network functions (e.g., one slice may include a first instance of SMF/PGW-C 720, PCF/PCRF 725, UPF/PGW-U 735, HSS/UDM 740, and/or 745, while another slice may include a second instance of SMF/PGW-C 720, PCF/PCRF 725, UPF/PGW-U 735, HSS/UDM 740, and/or 745). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. Alternatively and/or additionally, one or more of the devices of environment 700 may perform one or more network functions described as being performed by another one or more of the devices of environment 700. Devices of environment 700 may interconnect with each other and/or other devices via wired connections, wireless connections, or a combination of wired and wireless connections. In some implementations, one or more devices of environment 700 may be physically integrated in, and/or may be physically attached to, one or more other devices of environment 700.

UE 703 may include a computation and communication device, such as a wireless mobile communication device that is capable of communicating with RAN 710, RAN 712, and/or DN 750. UE 703 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 703 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 703 may communicate with one or more other elements of environment 700. UE 703 may communicate with RAN 710 via an air interface (e.g., as provided by gNB 711). For instance, RAN 710 may receive traffic (e.g., voice call traffic, data traffic, messaging traffic, signaling traffic, etc.) from UE 703 via the air interface, and may communicate the traffic to UPF/PGW-U 735, and/or one or more other devices or networks. Similarly, RAN 710 may receive traffic intended for UE 703 (e.g., from UPF/PGW-U 735, AMF 715, and/or one or more other devices or networks) and may communicate the traffic to UE 703 via the air interface.

RAN 712 may be, or may include, a LTE RAN that includes one or more base stations (e.g., one or more eNBs 713), via which UE 703 may communicate with one or more other elements of environment 700. UE 703 may communicate with RAN 712 via an air interface (e.g., as provided by eNB 713). For instance, RAN 710 may receive traffic (e.g., voice call traffic, data traffic, messaging traffic, signaling traffic, etc.) from UE 703 via the air interface, and may communicate the traffic to UPF/PGW-U 735, and/or one or more other devices or networks. Similarly, RAN 710 may receive traffic intended for UE 703 (e.g., from UPF/PGW-U 735, SGW 717, and/or one or more other devices or networks) and may communicate the traffic to UE 703 via the air interface.

AMF 715 may include one or more devices, systems, Virtualized Network Functions (“VNFs”), etc., that perform operations to register UE 703 with the 5G network, to establish bearer channels associated with a session with UE 703, to hand off UE 703 from the 5G network to another network, to hand off UE 703 from the other network to the 5G network, manage mobility of UE 703 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, etc., that perform operations to register UE 703 with the EPC, to establish bearer channels associated with a session with UE 703, to hand off UE 703 from the EPC to another network, to hand off UE 703 from another network to the EPC, manage mobility of UE 703 between RANs 712 and/or eNBs 713, and/or to perform other operations.

SGW 717 may include one or more devices, systems, VNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, etc., that gather, process, store, and/or provide information in a manner described herein. SMF/PGW-C 720 may, for example, facilitate in the establishment of communication sessions on behalf of UE 703. In some embodiments, the establishment of communications sessions may be performed in accordance with one or more policies provided by PCF/PCRF 725.

PCF/PCRF 725 may include one or more devices, systems, VNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, etc., that receive, store, and/or provide information that may be used in determining parameters (e.g., quality of service parameters, charging parameters, or the like) for certain applications.

UPF/PGW-U 735 may include one or more devices, systems, VNFs, etc., that receive, store, and/or provide data (e.g., user plane data). For example, UPF/PGW-U 735 may receive user plane data (e.g., voice call traffic, data traffic, etc.), destined for UE 703, from DN 750, and may forward the user plane data toward UE 703 (e.g., via RAN 710, SMF/PGW-C 720, and/or one or more other devices). In some embodiments, multiple UPFs 735 may be deployed (e.g., in different geographical locations), and the delivery of content to UE 703 may be coordinated via the N9 interface (e.g., as denoted in FIG. 7 by the line marked “N9” originating and terminating at UPF/PGW-U 735). Similarly, UPF/PGW-U 735 may receive traffic from UE 703 (e.g., via RAN 710, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

HSS/UDM 740 and AUSF 745 may include one or more devices, systems, VNFs, etc., that manage, update, and/or store, in one or more memory devices associated with AUSF 745 and/or HSS/UDM 740, profile information associated with a subscriber. AUSF 745 and/or HSS/UDM 740 may perform authentication, authorization, and/or accounting operations associated with the subscriber and/or a communication session with UE 703.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 703 may communicate, through DN 750, with data servers, other UEs UE 703, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 703 may communicate.

The network performance evaluation system 751 may include one or more devices, systems, VNFs, etc., that perform one or more operations described herein, such as one or more of the operations described with respect to the network performance evaluation system 112.

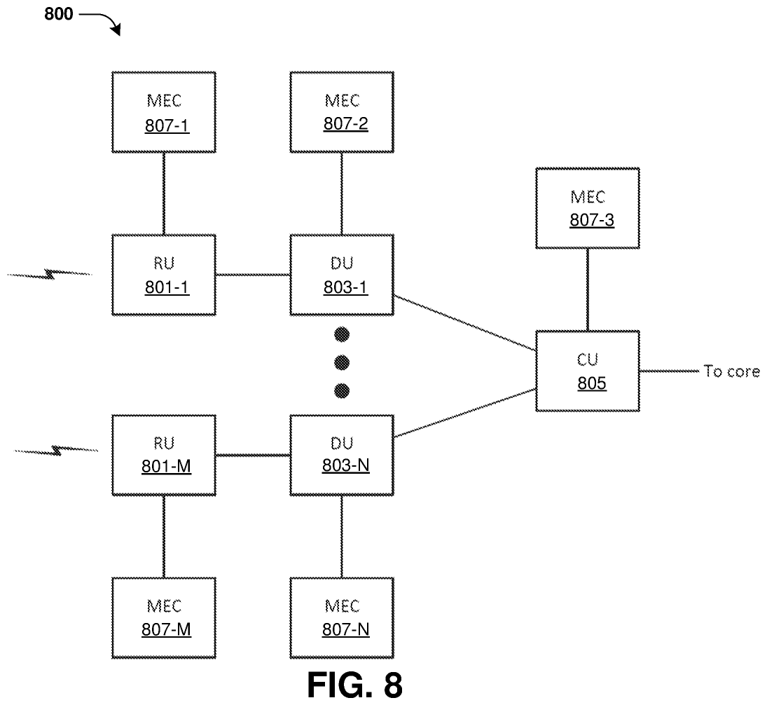

FIG. 8 illustrates an example Distributed Unit (“DU”) network 800, which may be included in and/or implemented by one or more RANs (e.g., RAN 710, RAN 712, or some other RAN). In some embodiments, a particular RAN may include one DU network 800. In some embodiments, a particular RAN may include multiple DU networks 800. In some embodiments, DU network 800 may correspond to a particular gNB 711 of a 5G RAN (e.g., RAN 710). In some embodiments, DU network 800 may correspond to multiple gNBs 711. In some embodiments, DU network 800 may correspond to one or more other types of base stations of one or more other types of RANs. As shown, DU network 800 may include Central Unit (“CU”) 805, one or more Distributed Units (“DUs”) 803-1 through 803-N (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 715 and/or UPF/PGW-U 735). In the uplink direction (e.g., for traffic from UEs UE 703 to a core network), CU 805 may aggregate traffic from DUs 803, and forward the aggregated traffic to the core network. In some embodiments, CU 805 may receive traffic according to a given protocol (e.g., Radio Link Control (“RLC”)) from DUs 803, and may perform higher-layer processing (e.g., may aggregate/process RLC packets and generate Packet Data Convergence Protocol (“PDCP”) packets based upon the RLC packets) on the traffic received from DUs 803.

In accordance with some embodiments, CU 805 may receive downlink traffic (e.g., traffic from the core network) for a particular UE 703, and may determine which DU(s) 803 should receive the downlink traffic. DU 803 may include one or more devices that transmit traffic between a core network (e.g., via CU 805) and UE 703 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 703.

RU 801 may include hardware circuitry (e.g., one or more RF transceivers, antennas, radios, and/or other suitable hardware) to communicate wirelessly (e.g., via an RF interface) with one or more UEs UE 703, one or more other DUs 803 (e.g., via RUs 801 associated with DUs 803), and/or any other suitable type of device. In the uplink direction, RU 801 may receive traffic from UE 703 and/or another DU 803 via the RF interface and may provide the traffic to DU 803. In the downlink direction, RU 801 may receive traffic from DU 803, and may provide the traffic to UE 703 and/or another DU 803.

RUs 801 may, in some embodiments, be communicatively coupled to one or more Multi-Access/Mobile Edge Computing (“MEC”) devices, referred to sometimes herein simply as (“MECs”) 807. For example, RU 801-1 may be communicatively coupled to MEC 807-1, RU 801-M may be communicatively coupled to MEC 807-M, DU 803-1 may be communicatively coupled to MEC 807-2, DU 803-N may be communicatively coupled to MEC 807-N, CU 805 may be communicatively coupled to MEC 807-3, and so on. MECs 807 may include hardware resources (e.g., configurable or provisionable hardware resources) that may be configured to provide services and/or otherwise process traffic to and/or from UE 703, via a respective RU 801.

For example, RU 801-1 may route some traffic, from UE 703, to MEC 807-1 instead of to a core network (e.g., via DU 803 and CU 805). MEC 807-1 may process the traffic, perform one or more computations based upon the received traffic, and may provide traffic to UE 703 via RU 801-1. In this manner, ultra-low latency services may be provided to UE 703, as traffic does not need to traverse DU 803, CU 805, and an intervening backhaul network between DU network 800 and the core network. In some embodiments, MEC 807 may include, and/or may implement some or all of the functionality described above with respect to the second node 80 (e.g., the application server that hosts resources of the first application). Alternatively and/or additionally, MEC 807 may include, and/or may implement some or all of the functionality described above with respect to the network performance evaluation system 112.

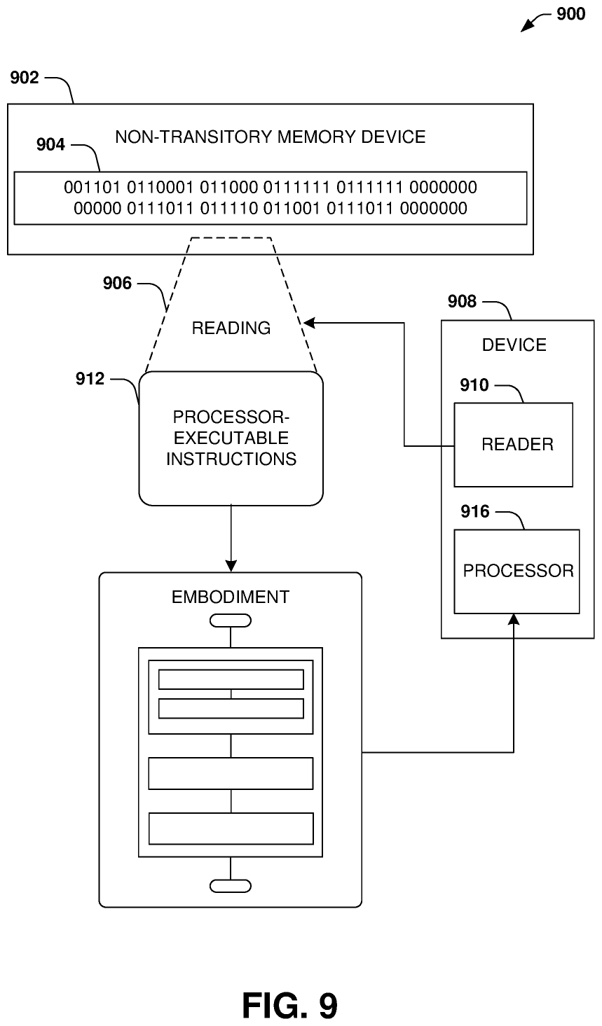

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example method 200 of FIG. 2, at least some of the example method 300 of FIGS. 3A-3B, and/or at least some of the example method 600 of FIG. 6, for example. In some embodiments, the processor-executable instructions 912 are configured to cause implementation of a system, such as at least some of the example system 101 of FIGS. 1A-1B, for example.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
providing a User Equipment (UE) with an indication of one or more first network performance tests associated with communication between the UE and a first testing computer;
providing the UE with an indication of one or more second network performance tests associated with communication between the UE and a second testing computer;
receiving one or more first test results of the one or more first network performance tests;
receiving one or more second test results of the one or more second network performance tests;
determining, based upon the one or more first test results, one or more first network performance metrics associated with the communication between the UE and the first testing computer;
determining, based upon the one or more second test results, one or more second network performance metrics associated with the communication between the UE and the second testing computer; and
determining a network performance issue based upon a comparison of one or more reference metrics with at least one of the one or more first network performance metrics or the one or more second network performance metrics.

2. The method of claim 1, wherein at least one of:
the one or more first network performance tests are performed over one or more wireless connections between the UE and a node of a network; or
the one or more second network performance tests are performed over one or more wireless connections between the UE and the node.

3. The method of claim 2, wherein:
the node comprises a wireless communication site of a telecommunication service provider.

4. The method of claim 3, wherein:
the network corresponds to an internal network, of the telecommunication service provider, comprising:
the wireless communication site;
the first testing computer; and
a core network;
the one or more first network performance tests are performed over the core network;
the second testing computer is connected to a public network; and
the one or more second network performance tests are performed over the core network and the public network.

5. The method of claim 4, comprising:
isolating a problem area associated with the network performance issue to a first region of interest associated with the internal network based upon a first network performance metric of the one or more first network performance metrics not meeting a first network performance metric threshold of the one or more reference metrics; or
isolating the problem area associated with the network performance issue to a second region of interest associated with the public network based upon:
the first network performance metric of the one or more first network performance metrics meeting the first network performance metric threshold; and
a second network performance metric of the one or more second network performance metrics not meeting a second network performance threshold of the one or more reference metrics.

6. The method of claim 2, comprising:
isolating a problem area of the network performance issue to a radio frequency (RF) connection condition associated with a wireless connection between the UE and the node based upon an RF connection metric of the one or more first network performance metrics not meeting a threshold RF connection metric of the one or more reference metrics.

7. The method of claim 2, wherein:
the one or more first network performance tests comprise at least one of:
an uplink (UL) network performance test in which the UE transmits first data to the first testing computer, wherein a test result of the UL network performance test is based upon a measure of data, of the first data transmitted by the UE, received by the first testing computer within a first time period associated with the UL network performance test; or
a downlink (DL) network performance test in which the first testing computer transmits second data to the UE, wherein a test result of the DL network performance test is based upon a measure of data, of the second data transmitted by the first testing computer, received by the UE within a second time period associated with the DL network performance test.

8. The method of claim 7, comprising:
determining a UL network performance metric based upon the test result of the UL network performance test; and
isolating a problem area of the network performance issue to UL congestion associated with a wireless connection between the UE and the node based upon the UL network performance metric not meeting a UL network performance metric threshold of the one or more reference metrics.

9. The method of claim 7, comprising:
determining a DL network performance metric based upon the test result of the DL network performance test; and
isolating a problem area of the network performance issue to DL congestion associated with a wireless connection between the UE and the node based upon the DL network performance metric not meeting a DL network performance metric threshold of the one or more reference metrics.

10. The method of claim 9, comprising:
determining a second DL network performance metric associated with operation of the node when a congestion level of the node does not meet a threshold congestion level; and
determining the DL network performance metric threshold based upon the second DL network performance metric.

11. The method of claim 7, wherein at least one of:
the UL network performance test comprises a UL User Datagram Protocol (UDP) network performance test; or
the DL network performance test comprises a DL UDP network performance test.

12. The method of claim 2, wherein:
the one or more first network performance tests comprise an uplink (UL) User Datagram Protocol (UDP) network performance test in which the UE transmits first data to the first testing computer, wherein a test result of the UL UDP network performance test is based upon a measure of data, of the first data transmitted by the UE, received by the first testing computer within a first time period associated with the UL UDP network performance test; and
the one or more first network performance tests comprise a download Transmission Control Protocol (TCP) network performance test in which the first testing computer transmits second data to the UE, wherein a test result of the download TCP network performance test is based upon at least one of:
a duration of time between:
a transmission of data by the first testing computer to the UE during the download TCP network performance test; and
reception of an acknowledgment, by the first testing computer, indicating reception of the transmission of data by the UE; or
a measure of data received by the UE from the first testing computer within a second time period associated with the download TCP network performance test.

13. The method of claim 12, wherein:
determining the one or more first network performance metrics comprises determining at least one of:
a UL UDP network performance metric based upon the test result of the UL UDP network performance test;
a round trip time metric based upon the test result of the download TCP network performance test; or
a TCP download network performance metric based upon the test result of the download TCP network performance test.

14. The method of claim 13, comprising:
isolating a problem area of the network performance issue to a UL bandwidth condition associated with a wireless connection between the UE and the node based upon at least one of:
the UL UDP network performance metric not meeting a UL UDP network performance metric threshold of the one or more reference metrics;
the round trip time metric not meeting a round trip time metric threshold of the one or more reference metrics; or
the TCP download network performance metric not meeting a TCP download network performance metric threshold of the one or more reference metrics.

15. The method of claim 13, comprising:
isolating a problem area of the network performance issue to congestion associated with a core network based upon at least one of:
the UL UDP network performance metric not meeting a UL UDP network performance metric threshold of the one or more reference metrics;
the round trip time metric meeting a round trip time metric threshold of the one or more reference metrics; or
the TCP download network performance metric meeting a TCP download network performance metric threshold of the one or more reference metrics,
wherein:
the node comprises a wireless communication site of a telecommunication service provider;
the network corresponds to an internal network, of the telecommunication service provider, comprising:
the wireless communication site;
the first testing computer; and
the core network; and
at least one of:
the UL UDP network performance test is performed over the core network; or
the download TCP network performance test is performed over the core network.

16. The method of claim 5, wherein:
the one or more first network performance tests comprise at least one of:
an internal upload Transmission Control Protocol (TCP) network performance test in which the UE transmits first data to the first testing computer, wherein a test result of the internal upload TCP network performance test is based upon a measure of data received by the second testing computer within a first time period associated with the internal upload TCP network performance test; or
an internal download TCP network performance test in which the first testing computer transmits second data to the UE over the core network, wherein a test result of the internal download TCP network performance test is based upon a measure of data received by the UE within a second time period associated with the internal download TCP network performance test;
the one or more second network performance tests comprise at least one of:
an external upload TCP network performance test in which the UE transmits third data to the second testing computer, wherein a test result of the external upload TCP network performance test is based upon a measure of data received by the second testing computer within a third time period associated with the external upload TCP network performance test; or
an external download TCP network performance test in which the second testing computer transmits fourth data to the UE over the core network, wherein a test result of the external download TCP network performance test is based upon a measure of data received by the UE within a fourth time period associated with the external download TCP network performance test; and
at least one of:
determining the one or more first network performance metrics comprises determining at least one of:
an internal upload TCP network performance metric based upon the test result of the internal upload TCP network performance test; or
an internal download TCP network performance metric based upon the test result of the internal download TCP network performance test; or
determining the one or more second network performance metrics comprises determining at least one of:
an external upload TCP network performance metric based upon the test result of the external upload TCP network performance test; or
an external download TCP network performance metric based upon the test result of the external download TCP network performance test.

17. The method of claim 16, comprising:
at least one of:
determining an external upload TCP network performance metric threshold of the one or more reference metrics based upon the internal upload TCP network performance metric; or
determining an external download TCP network performance metric threshold of the one or more reference metrics based upon the internal download TCP network performance metric; and
isolating a problem area of the network performance issue to congestion associated with the public network based upon at least one of:
the external upload TCP network performance metric not meeting the external upload TCP network performance metric threshold; or
the external download TCP network performance metric not meeting the external download TCP network performance metric threshold.

18. A method comprising:
receiving, by a User Equipment (UE) and from a network performance evaluation system, a set of instructions;
executing, by the UE, the set of instructions to:
perform first communication with a first testing computer and derive a first network performance test result based upon the first communication; and
perform second communication with a second testing computer and derive a second network performance test result based upon the second communication; and
transmitting the first network performance test result and the second network performance test result to the network performance evaluation system.

19. The method of claim 18, wherein:
at least one of the first network performance test result or the second network performance test result is used to determine a network performance issue.

20. A computer comprising:
a processor, the processor configured to execute instructions to perform operations comprising:
providing a User Equipment (UE) with an indication of one or more first network performance tests associated with communication between the UE and a first testing computer;
providing the UE with an indication of one or more second network performance tests associated with communication between the UE and a second testing computer;
receiving one or more first test results of the one or more first network performance tests;
receiving one or more second test results of the one or more second network performance tests;
determining, based upon the one or more first test results, one or more first network performance metrics associated with the communication between the UE and the first testing computer;
determining, based upon the one or more second test results, one or more second network performance metrics associated with the communication between the UE and the second testing computer; and
determining a network performance issue based upon a comparison of one or more reference metrics with at least one of the one or more first network performance metrics or the one or more second network performance metrics.
